(19) United States
(12) Patent Application Publication
(10) Pub. No.: US 2014/0286255 A1
(43) Pub. Date: Sep. 25, 2014

(54) UPLINK DEMODULATION REFERENCE SIGNALS IN ADVANCED WIRELESS COMMUNICATION SYSTEMS

(71) Applicant: Samsung Electronics Co., Ltd., Suwon-si (KR)

(72) Inventors: Young-Han Nam, Plano, TX (US); Aris Papasakellariou, Houston, TX (US)

(73) Assignee: Samsung Electronics Co., Ltd., Suwon-si (KR)

(21) Appl. No.: 14/223,839

(22) Filed: Mar. 24, 2014

Related U.S. Application Data
(60) Provisional application No. 61/805,023, filed on Mar. 25, 2013.
(60) Provisional application No. 61/845,770, filed on Jul. 12, 2013.

(51) Int. Cl. H04W 72/04; H04L 1/18

(52) U.S. Cl. CPC H04W 72/0413; H04L 1/1861
USPC 370/329

(57) ABSTRACT

User equipment is provided to communicate with a base station. The user equipment includes a transceiver. The transceiver configured to transmit a physical uplink shared channel (PUSCH). A DMRS is mapped on a single, single carrier frequency division multiplexing (SC-FDM) symbol of a subframe. Data and acknowledgement (HARQ-ACK) information is mapped on remaining SC-FDM symbols of the subframe. The HARQ-ACK information is mapped on virtual subcarriers on two SC-FDM symbols next to the single SC-FDM symbol with the DMRS.

### CROSS-REFERENCE TO RELATED APPLICATION(S) AND CLAIM OF PRIORITY

The present application is related to U.S. Provisional Patent Application No. 61/805,023, filed Mar. 25, 2013, entitled “UPLINK DEMODULATION REFERENCE SIGNALS IN ADVANCED WIRELESS COMMUNICATION SYSTEMS,” and U.S. Provisional Patent Application No. 61/845,770, filed Jul. 12, 2013, entitled “UPLINK DEMODULATION REFERENCE SIGNALS IN ADVANCED WIRELESS COMMUNICATION SYSTEMS.” Provisional Patent Application Nos. 61/805,023 and 61/845,770 are assigned to the assignee of the present application and are hereby incorporated by reference into the present application as if fully set forth herein. The present application hereby claims priority under 35 U.S.C. §119 (e) to U.S. Provisional Patent Application Nos. 61/805,023 and 61/845,770.

### TECHNICAL FIELD

The present application relates generally to wireless communications and, more specifically, to a method and system for reference signal (RS) pattern design.

### BACKGROUND

In 3^{rd} Generation Partnership Project Long Term Evolution (3GPP LTE), Orthogonal Frequency Division Multiplexing (OFDM) is adopted as an uplink (UL) transmission scheme.

### SUMMARY

User equipment is provided to communicate with a base station. The user equipment includes a transceiver. The transceiver configured to transmit a Physical Uplink Shared Channel (PUSCH). A DeModulation Reference Signal (DMRS) is mapped on a single, Single Carrier Frequency Division Multiplexing (SC-FDM) symbol of a subframe. Data and acknowledgement (HARQ-ACK) information is mapped on remaining SC-FDM symbols of the subframe. The HARQ-ACK information is mapped on virtual subcarriers on two SC-FDM symbols next to the single SC-FDM symbol with the DMRS.

A base station is provided to communicate with user equipment. The base station includes a transceiver. The transceiver configured to receive a Physical Uplink Shared Channel (PUSCH). A DeModulation Reference Signal (DMRS) is mapped on a single, Single Carrier Frequency Division Multiplexing (SC-FDM) symbol of a subframe. Data and acknowledgement (HARQ-ACK) information is mapped on remaining SC-FDM symbols of the subframe. The HARQ-ACK information is mapped on virtual subcarriers on two SC-FDM symbols next to the single SC-FDM symbol with the DMRS.

A method is provided for communicating with a base station. The method includes transmitting a Physical Uplink Shared Channel (PUSCH). A DeModulation Reference Signal (DMRS) is mapped on a single, Single Carrier Frequency Division Multiplexing (SC-FDM) symbol of a subframe. Data and acknowledgement (HARQ-ACK) information is mapped on remaining SC-FDM symbols of the subframe. The HARQ-ACK information is mapped on virtual subcarriers on two SC-FDM symbols next to the single SC-FDM symbol with the DMRS.

A method is provided for communicating with user equipment. The method includes receiving a Physical Uplink Shared Channel (PUSCH). A DeModulation Reference Signal (DMRS) is mapped on a single, Single Carrier Frequency Division Multiplexing (SC-FDM) symbol of a subframe. Data and acknowledgement (HARQ-ACK) information is mapped on remaining SC-FDM symbols of the subframe. The HARQ-ACK information is mapped on virtual subcarriers on two SC-FDM symbols next to the single SC-FDM symbol with the DMRS.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that transmits messages in the uplink according to the principles of the present disclosure;

FIG. 2 illustrates a high-level diagram of an OFDMA transmitter according to one embodiment of the disclosure;

FIG. 3 illustrates a high-level diagram of an OFDMA receiver according to one embodiment of the disclosure;

FIG. 4 illustrates PUSCH and PUSCH DMRS mapping in one PRB pair of a normal CP uplink subframe in a 3GPP LTE system according to an embodiment of the disclosure;

FIG. 5 illustrates a single PRB for UCI multiplexing on PUSCH and SRS transmissions, when a UE is assigned with a single PRB for an UL according to an embodiment of the disclosure;

FIGS. 6A-6F illustrate alternative methods to reduce UL DMRS overhead according to an embodiment of the disclosure;

FIG. 7 illustrates an alternative pattern for UCI mapping on PUSCH according to an embodiment of the disclosure;

FIG. 8 illustrates an alternative pattern for UCI mapping on PUSCH transmission to a UE according to an embodiment of the disclosure;

FIG. 9 illustrates a process of an alternative for UCI mapping on PUSCH according to an embodiment of the disclosure;

FIG. 10 illustrates an alternative pattern for UCI mapping on PUSCH transmission to a UE according to an embodiment of the disclosure;

FIGS. 11A-11D illustrate methods for reducing PUSCH DMRS overhead according to an embodiment of the disclosure;

FIGS. 12A and 12B illustrate methods for mapping a DMRS sequence across DMRS REs according to an embodiment of the disclosure;

FIG. 13 illustrates a process showing the values for G and Cₘᵤₓ change depending upon whether or not reduced-overhead DMRS is used for a PUSCH transmission according to an embodiment of the disclosure; and

FIG. 14 illustrates PAPR comparison results for transform precoding according to an embodiment of the disclosure.

### DETAILED DESCRIPTION

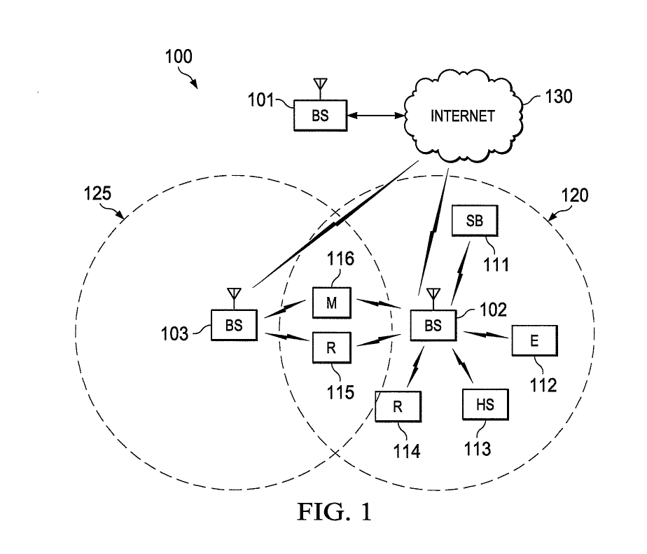

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

With regard to the following description, it is noted that the LTE term “Node B” is another term for “base station” used below. Also, the LTE term “user equipment” or “UE” is another term for “subscriber station” used below.

FIG. 1 illustrates exemplary wireless network 100, which transmits messages according to the principles of the present disclosure. In the illustrated embodiment, wireless network 100 includes base station (BS) 101, base station (BS) 102, base station (BS) 103, and other similar base stations (not shown).

Base station 101 is in communication with Internet 130 or a similar IP-based network (not shown).

Base station 102 provides wireless broadband access to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

While only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

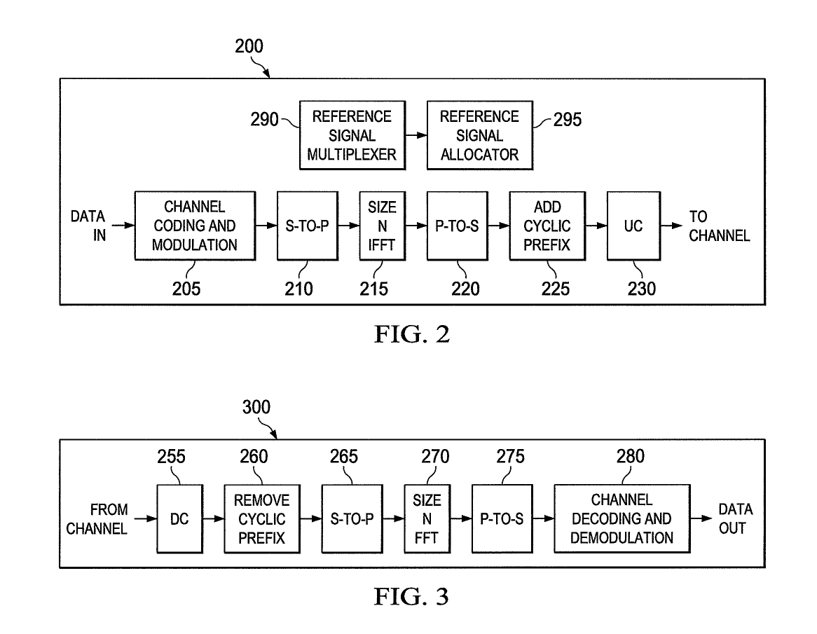

FIG. 2 illustrates a high-level diagram of an orthogonal frequency division multiple access (OFDMA) transmit path 200. FIG. 3 illustrates a high-level diagram of an orthogonal frequency division multiple access (OFDMA) receive path 300. In FIGS. 2 and 3, the OFDMA transmit path 200 is implemented in base station (BS) 102 and the OFDMA receive path 300 is implemented in subscriber station (SS) 116 for the purposes of illustration and explanation only. However, it will be understood by those skilled in the art that the OFDMA receive path 300 may also be implemented in BS 102 and the OFDMA transmit path 200 may be implemented in SS 116.

The transmit path 200 in BS 102 comprises a channel coding and modulation block 205, a serial-to-parallel (S-to-P) block 210, a Size N Inverse Fast Fourier Transform (IFFT) block 215, a parallel-to-serial (P-to-S) block 220, an add cyclic prefix block 225, an up-converter (UC) 230, a reference signal multiplexer 290, and a reference signal allocator 295.

The receive path 300 in SS 116 comprises a down-converter (DC) 255, a remove cyclic prefix block 260, a serial-to-parallel (S-to-P) block 265, a Size N Fast Fourier Transform (FFT) block 270, a parallel-to-serial (P-to-S) block 275, and a channel decoding and demodulation block 280.

At least some of the components in FIGS. 2 and 3 may be implemented in software while other components may be implemented by configurable hardware or a mixture of software and configurable hardware. In particular, it is noted that the FFT blocks and the IFFT blocks described in the present disclosure document may be implemented as configurable software algorithms, where the value of Size N may be modified according to the implementation.

Furthermore, although the present disclosure is directed to an embodiment that implements the Discrete Fourier Transform (DFT) functions and Inverse Discrete Fourier Transform (IDFT) functions, this is by way of illustration only and should not be construed to limit the scope of the disclosure. It will be appreciated that in an alternate embodiment of the disclosure, the Discrete Fourier Transform (DFT) functions and Inverse Discrete Fourier Transform (IDFT) functions may easily be replaced by Fast Fourier Transform functions and the Inverse Fast Fourier Transform functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency. In some embodiments, reference signal multiplexer 290 is operable to multiplex the reference signals using code division multiplexing (CDM) or time/frequency division multiplexing (TFDM). Reference signal allocator 295 is operable to dynamically allocate reference signals in an OFDM signal in accordance with the methods and system disclosed in the present disclosure.

The transmitted RF signal arrives at SS 116 after passing through the wireless channel and reverse operations performed at BS 102. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure describes a method and system for reference signal (RS) pattern design.

In LTE, DL RSs are used for two purposes. First, UEs determine channel quality information (CQI), rank indicator (RI) and precoder matrix information (PMI) using DL RSs. Second, each UE demodulates DL transmission signals using the DL RSs. In addition, DL RSs are divided into three categories: cell-specific RSs, multi-media broadcast over a single frequency network (MBSFN) RSs, and UE-specific RSs Demodulation RS (DMRS).

Cell-specific reference signals (or common reference signals, CRSs) are transmitted in all DL subframes in a cell supporting non-MBSFN transmission. If a subframe is used for transmission with MBS FN, only the first a few (0, 1 or 2) OFDM symbols in a subframe can be used for transmission of cell-specific reference symbols. The notation Rₚ is used to denote a resource element used for RS transmission on antenna port p.

DMRS is supported for single-antenna-port transmission of Physical Downlink Shared Channel (PDSCH) and are transmitted on antenna port 5. The UE is informed by higher layer signaling, such as Radio Resource Control (RRC) signaling, whether the UE-specific DMRS is present and is a valid phase reference for PDSCH demodulation or not. UE-specific reference signals are transmitted only in the resource blocks (RBs) upon which the corresponding PDSCH is also transmitted.

The time resources of an LTE system are partitioned into 10 msec frames, and each frame is further partitioned into 10 subframes of one msec duration each. A subframe is divided into two time slots, each of which spans 0.5 msec. A subframe is partitioned in the frequency domain into multiple RBs, where an RB is composed of 12 subcarriers.

The following documents and standards descriptions are hereby incorporated into the present disclosure as if fully set forth herein:
REF1—3GPP TS 36.211 v11.2.0, “E-UTRA, Physical channels and modulation”;
REF2—3GPP TS 36.212 v11.2.0, “E-UTRA, Multiplexing and Channel coding”; and
REF3—3GPP TS 36.213 v11.2.0, “E-UTRA, Physical Layer Procedures.”

List of acronyms:
eNB=enhanced node B
UE=user equipment
CA=carrier aggregation
UL=uplink
DL=downlink
UL-SCH=uplink shared channel for data transport block
SC-FDM=single carrier frequency division multiplexing
CP=cyclic prefix
PRB=physical resource block
UCI=uplink control information
SRS=sounding reference signals
SINR=signal to interference and noise ratio
BW=bandwidth
TTI=transmission time interval
TB=transport block
PUSCH=physical uplink shared channel
PDCCH=physical downlink control channel
RS=reference signal
DMRS=demodulation reference signal
HARQ=hybrid automatic repeat-request
HARQ-ACK or A/N=HARQ ACKnowledgement information
DCI=downlink control information
RRC=radio resource control (higher layer signaling)
TM=transmission mode

For the purposes of this disclosure, the following symbols apply:
N_{RB}^{DL} DL BW configuration, expressed in number of RBs (see also REF1)
N_{RB}^{UL} UL BW configuration, expressed m number of RBs (see also REF1)
N_{sc}^{RB} RB size in the frequency domain, expressed as a number of subcarriers
N_{symb}^{PUSCH} Number of SC-FDMA symbols carrying PUSCH in a subframe
N_{symb}^{PUSCH-initial} Number of SC-FDMA symbols carrying PUSCH in the initial PUSCH transmission subframe
N_{symb}^{UL} Number of SC-FDMA symbols m an uplink slot
N_{SRS} Number of SC-FDMA symbols used for SRS transmission in a subframe (0 or 1).

PUSCH and PUSCH DMRS in the Legacy LTE Systems:

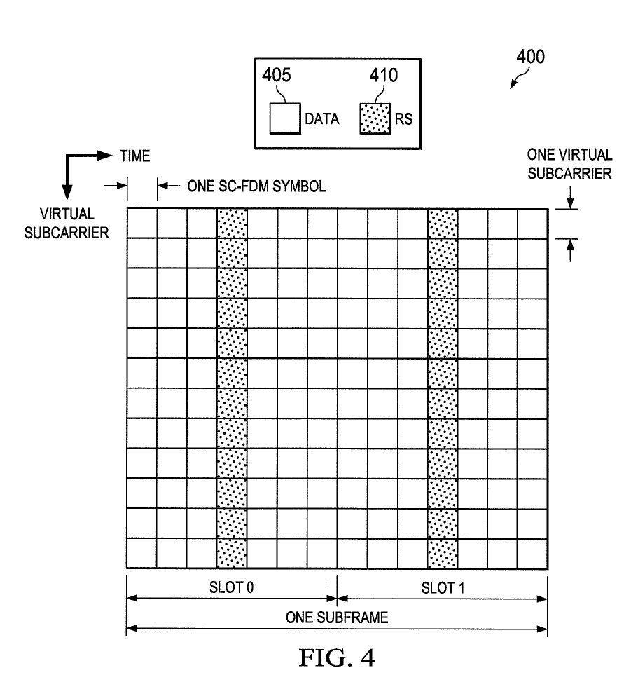

FIG. 4 illustrates PUSCH and PUSCH DMRS mapping in one PRB pair of a normal CP UL subframe 400 in a 3GPP LTE system according to an embodiment of the disclosure. Subframe 400 can include data 405, reference signals 410, slot 0, and slot 1.

A minimum, scheduling unit to carry a TB in the LTE UL is a PRB pair, which spans 1 msec in the time domain and 12 subcarriers in the frequency domain. The 1 msec is referred to the subframe 400, which is further partitioned into two time slots, slot 0 and slot 1. Each time slot comprises 7 single-carrier FDM (SC-FDM) symbols if normal CP is configured; 6 SC-FDM symbols if extended CP is configured.

When a UE is scheduled to transmit in N_{PRB} PRB pairs, the UE will be assigned, with 12 N_{PRB} subcarriers in each SC-FDM symbol. In each SC-FDM symbol, the PUSCH data modulation symbols are first mapped to the same number of virtual subcarriers as the scheduled number of subcarriers, i.e., 12 N_{PRB}. The resource indexed by a virtual subcarrier and an OFDM symbol is called virtual resource element (vRE). Then, the UE shall apply transform precoding (i.e., DFT precoding) to transform the data 405 into the frequency domain and map the transformed data symbols on the 12 N_{PRB} subcarriers. The resource indexed by a subcarrier and an OFDM symbol is called resource element (RE).

The UE shall map a PUSCH DMRS sequence onto the subcarriers in the fourth SC-FDM symbol in the assigned BW in each time slot in normal CP subframes.

M_{sc}^{PUSCH} is the scheduled bandwidth for PUSCH transmission in the current subframe for the TB, and N_{symb}^{PUSCH} is the number of SC-FDMA symbols in the current PUSCH transmission subframe given by N_{symb}^{PUSCH}=(2·(N_{symb}^{UL}−1)−N_{SRS}), where N_{SRS} is equal to 1 if UE transmits PUSCH and SRS in the same subframe for the current subframe, or if the PUSCH resource allocation for the current subframe even partially overlaps with the cell-specific SRS subframe and BW configuration defined in REF2, or if the current subframe is a UE-specific type-1 SRS subframe as defined in Section 8.2 of REF3, or if the current subframe is a UE-specific type-0 SRS subframe as defined in REF3 and the UE is configured with multiple TAGs. Otherwise N_{SRS} is equal to 0.

Number of UL-SCH Coded Bits:

N_{symb}^{PUSCH} and M_{sc}^{PUSCH} are used to determine the number of coded bits of UL-SCH data. For UL-SCH data information G=N_{L}^{(x)}·(N_{symb}^{PUSCH}·M_{sc}^{PUSCH}·Qₘ^{(x)}−Q_{CQI}−Q_{RI}^{(x)}), where N_{L}^{(x)} is the number of layers the corresponding UL-SCH TB is mapped onto, Qₘ^{(x)},x={1,2} is the modulation order of TB “x”, Q_{CQI} and Q_{RI}^{(x)} are the number of coded bits respectively for CQI and RI to be mapped onto the same layers as transport block x.

Transform Precoding:

M_{symb}^{layer} is the number of modulation symbols per layer. For each layer λ=0, 1, . . . , υ−1 the block of complex-valued symbols x^{(λ)(}0), . . . , x^{(λ)}(M_{symb}^{layer}−1) is divided into M_{symb}^{layer}/M_{sc}^{PUSCH} sets, each corresponding to one SC-FDMA symbol. Transform precoding shall be applied according to:

$${y}^{( λ )} ( l \cdot {M}_{sc}^{PUSCH} + k ) = \frac{1}{\sqrt{{M}_{sc}^{PUSCH}}} {\sum }_{i = 0}^{{M}_{sc}^{PUSCH} - 1} {x}^{( λ )} ( l \cdot {M}_{sc}^{ PUSCH} + i ) {e}^{- j \frac{2 πi k}{{M}_{sc}^{PUSCH}}} \\ k = 0 , … , {M}_{sc}^{ PUSCH} - 1 \\ l = 0 , … , {M}_{symb}^{layer} / {M}_{sc}^{PUSCH} - 1 \qquad ( 1 )$$

resulting in a block of complex-valued symbols y^{(λ)}(0), . . . , y^{(λ)}(M_{symb}^{layer}−1). The variable M_{sc}^{PUSCH}=M_{RB}^{PUSCH}·N_{sc}^{RB}, where M_{RB}^{PUSCH} represents the PUSCH BW in terms of RBs, and shall fulfil M_{RB}^{PUSCH}=2^{α}^{₂}·3^{α}^{₃}·5^{α}^{₅}≦N_{RB}^{UL} where α₂, α₃, α₅ is a get of non-negative integers.

PUSCH DMRS Sequence Generation:

The PUSCH demodulation reference signal sequence r_{PUSCH}^{(λ)}(•) associated with layer λε{0, 1, . . . , υ−1} is defined by

r_{PUSCH}^{(λ)}(m·M_{sc}^{RS}+n)=w^{(λ)}(m)r_{u,v}^{(α}^{ᵢ}⁾(n)

where

m=0,1

n=0, . . . , M_{sc}^{RS}−1 and

M_{sc}^{RS}=M_{sc}^{PUSCH}

Section 5.5.1 in REF1 defines the sequence r_{u,v}^{(α}^{_{λ}}⁾(0), . . . , r_{u,v}^{(α}^{_{λ}}⁾(M_{sc}^{RS}−1). The orthogonal sequence w^{(λ)}(m) is given by [w^{λ}(0) w^{λ}(1)]=[1 1] for DCI format 0 if the higher-layer parameter Activate-DMRS-with OCC is not set or if the temporary C-RNTI was used to transmit the most recent UL DCI for the TB associated with the corresponding PUSCH transmission, otherwise it is given by Table 1 using the cyclic shift field in most recent UL DCI format (see also REF2) for the TB associated with the corresponding PUSCH transmission.

The cyclic shift α_{λ} in a slot nₛ is given as α_{λ}=2πn_{cs,λ}/12 with

n_{cs,λ}=(n_{DMRS}⁽¹⁾+n_{DMRS,λ}⁽²⁾+n_{PN}(nₛ))mod 12
where the values of n_{DMRS}⁽¹⁾ is given by Table 2 according to the parameter cyclicShift provided by higher layers, n_{DMRS,λ}⁽²⁾ is given by the cyclic shift for DMRS field in most recent UL DCI format (see also REF3) for the TB associated with the corresponding PUSCH transmission where the value of n_{DMRS,λ}⁽²⁾ is given in Table 1.

The first row of Table 1 shall be used to obtain n_{DMRS,0}⁽²⁾ and w^{(λ)}(m) if there is no UL DCI format for the same TB associated with the corresponding PUSCH transmission, and
if the initial PUSCH for the same TB is semi-persistently scheduled, or
if the initial PUSCH for the same TB is scheduled by the random access response grant.

The quantity n_{PN}(nₛ) is given by n_{PN}(nₛ)=Σᵢ₌₀⁷c(8N_{symb}^{UL}·nₛ+i)·2ⁱ
where the pseudo-random sequence c(i) is defined in REF 1. The application of c(i) is cell-specific. The pseudo-random sequence generator shall be initialized with cᵢₙᵢₜ at the beginning of each radio frame. The quantity cᵢₙᵢₜ is given by

$${c}_{init} = ⌊ \frac{{N}_{ID}^{cell}}{30} ⌋ \cdot {2}^{5} + ( ( {N}_{ID}^{cell} + {Δ}_{ss} ) mod 30 )$$

if no value for N_{ID}^{csh}^{_{—}}^{DMRS} is configured by higher layers or the PUSCH transmission corresponds to a Random Access Response Grant or a retransmission of the same transport block as part of the contention based random access procedure, otherwise it is given by

$${c}_{init} = ⌊ \frac{{N}_{ID}^{csh\_DMRS}}{30} ⌋ \cdot {2}^{5} + ( {N}_{ID}^{csh\_DMRS} mod 30 ) .$$

The vector of reference signals shall be precoded according to:

$$[ \begin{matrix}{\tilde{r}}_{PUSCH}^{( 0 )} \\ ⋮ \\ {\tilde{r}}_{PUSCH}^{( P - 1 )}\end{matrix} ] = W [ \begin{matrix}{\tilde{r}}_{PUSCH}^{( 0 )} \\ ⋮ \\ {\tilde{r}}_{PUSCH}^{( υ - 1 )}\end{matrix} ] ,$$

where P is the number of antenna ports used for PUSCH transmission.

For PUSCH transmission using a single antenna port, P=1, W=1 and υ=1.

For spatial multiplexing, P=2 or P=4 and the precoding matrix W shall be identical to the precoding matrix used in REF 1 for precoding of the PUSCH in the same subframe.

TABLE 1
Mapping of Cyclic Shift Field in uplink-related DCI format
to n_{DMRS, λ}⁽²⁾ and [w^{(λ)} (0) w^{(λ)} (1)].

| Cyclic Shift Field | | | | | | | | |
|---|---|---|---|---|---|---|---|---|
| in uplink-related | n_{DMRS, λ}⁽²⁾ | | | | [w^{(λ)} (0) w^{(λ)} (1)] | | | |
| DCI format REF3 | λ = 0 | λ = 1 | λ = 2 | λ = 3 | λ = 0 | λ = 1 | λ = 2 | λ = 3 |
| 000 | 0 | 6 | 3 | 9 | [1 1] | [1 1] | [1 −1] | [1 −1] |
| 001 | 6 | 0 | 9 | 3 | [1 −1] | [1 −1] | [1 1] | [1 1] |
| 010 | 3 | 9 | 6 | 0 | [1 −1] | [1 −1] | [1 1] | [1 1] |
| 011 | 4 | 10 | 7 | 1 | [1 1] | [1 1] | [1 1] | [1 1] |
| 100 | 2 | 8 | 5 | 11 | [1 1] | [1 1] | [1 1] | [1 1] |
| 101 | 8 | 2 | 11 | 5 | [1 −1] | [1 −1] | [1 −1] | [1 −1] |
| 110 | 10 | 4 | 1 | 7 | [1 −1] | [1 −1] | [1 −1] | [1 −1] |
| 111 | 9 | 3 | 0 | 6 | [1 1] | [1 1] | [1 −1] | [1 −1] |

TABLE 2
Mapping of cyclicShift to n_{DMRS}⁽¹⁾ values.

| Cyclic Shift | n_{DMRS}⁽¹⁾ |
|---|---|
| 0 | 0 |
| 1 | 2 |
| 2 | 3 |
| 3 | 4 |
| 4 | 6 |
| 5 | 8 |
| 6 | 9 |
| 7 | 10 |

In REF 1, PUSCH DMRS sequence mapping to physical resources is described as in the following:

For each antenna port used for transmission of the PUSCH, the sequence \tilde{r}_{PUSCH}^{(\tilde{p})}(•) shall be multiplied with the amplitude scaling factor β_{PUSCH} and mapped in sequence starting with \tilde{r}_{PUSCH}^{(\tilde{p})}(•) to the RBs. The set of PRBs used in the mapping process and the relation between the index \tilde{p} and the antenna port number P shall be identical to the corresponding PUSCH transmission as defined in Section 5.3.4 in REF1. The mapping to REs (k,l), with l=3 for normal CP and l=2 for extended CP, in the subframe shall be in increasing order of first k, then the slot number.

UCI Multiplexing on PUSCH & SRS in the Legacy LTE Systems:

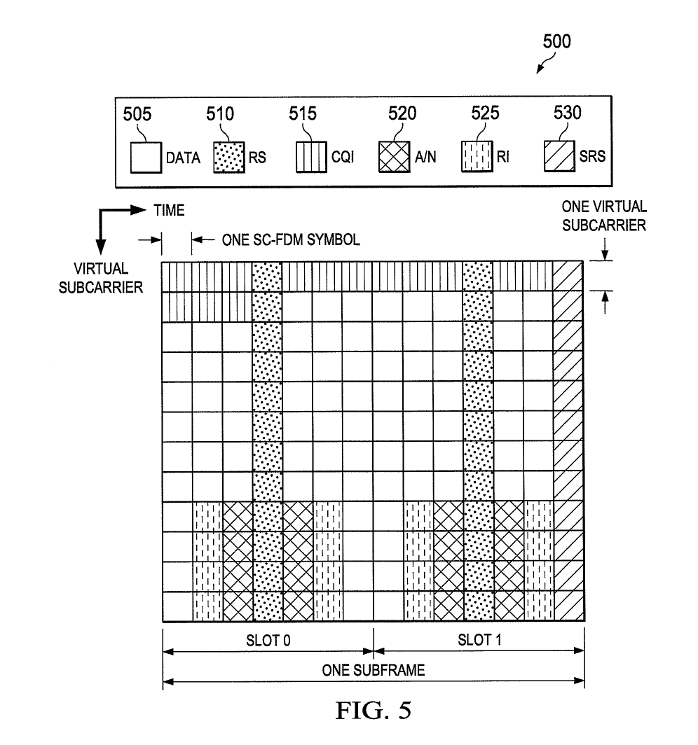

FIG. 5 illustrates a single PRB 500 for UCI multiplexing on a PUSCH and SRS transmissions, when a UE is assigned with the single PRB for transmission of the PUSCH according to an embodiment of the disclosure. In an embodiment, the single PRB 500 can include PUSCH data 505, RS 510, CQI 515, A/N 520, RI 525, SRS, 530, slot 0, and slot 1.

UCI may refer to at least one of CQI (or CQI/PMI), HARQ-ACK (or A/N), and RI (rank indicator).

The Q′ number of vREs to carry each types of UCI is determined by a function of the UCI payload, scheduled number of PRB pairs, TB size of the PUSCH and a semi-statically higher-layer configured scaling parameter, called β_{offset}^{PUSCH}. The value of β_{offset}^{PUSCH} is determined depending on the UCI type. REF 2 describes the association of β_{offset}^{PUSCH} to the UCI type, the multiplexing of each UCI type is a PUSCH transmission, and the determination of the number of REs for each UCI type in a PUSCH transmission.

FIG. 5 also illustrates that the last SC-FDM can be configured for SRS transmissions.

One or more embodiments recognizes and takes into account that, in legacy LTE systems, the PUSCH DMRS overhead is fixed to be SC-FDM symbols over an assigned PUSCH BW. Therefore, a PUSCH DMRS overhead is 2/14=14.3% in a normal CP subframe, and 16.7% in an extended CP subframe.

One or more embodiments recognizes and takes into account that, when a channel condition is relatively stable in at least one of time domain or frequency domain and an SINR experienced by a PUSCH transmission from a UE is sufficiently high, a high PUSCH DMRS overhead can unnecessarily limit UL throughput.

The present embodiments disclose methods and apparatuses to reduce UL DMRS overhead. Each method can be configured by an eNB and can be used for a respective UE in a favorable UL channel condition.

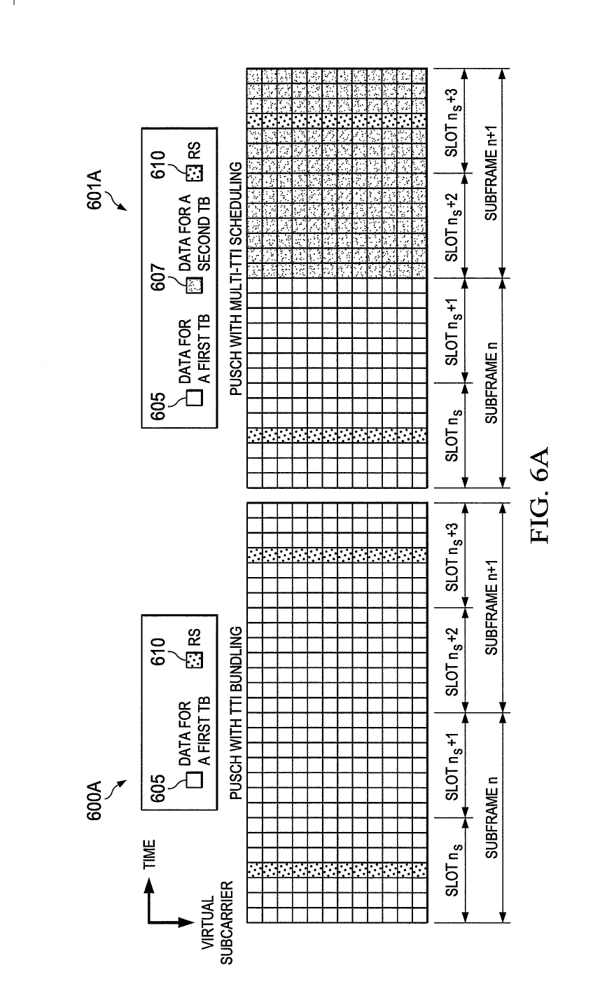

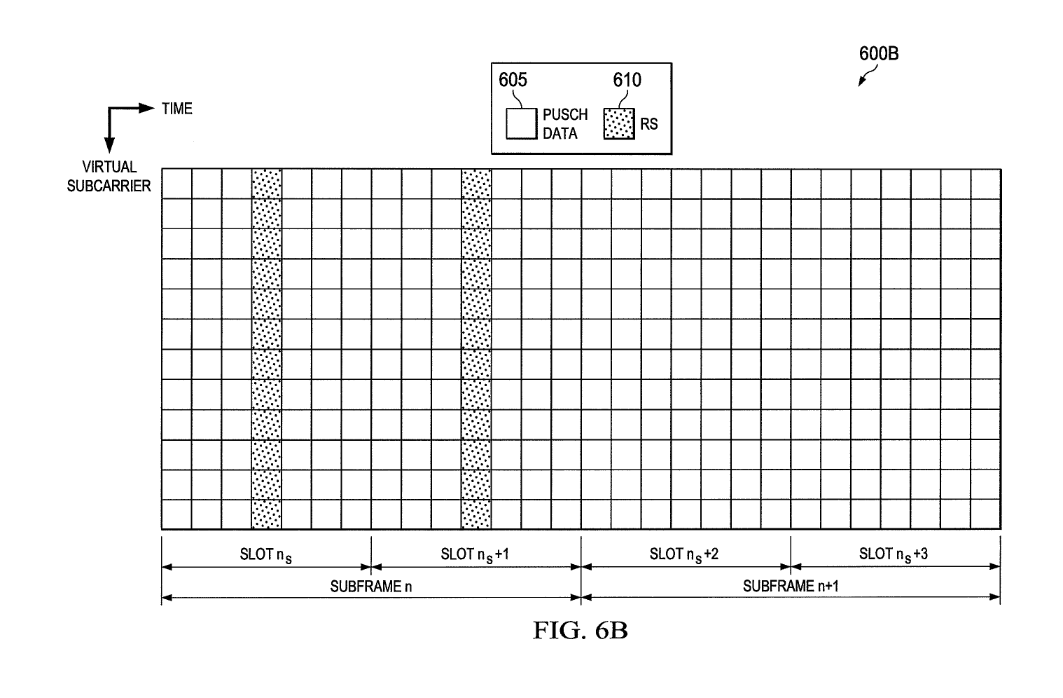

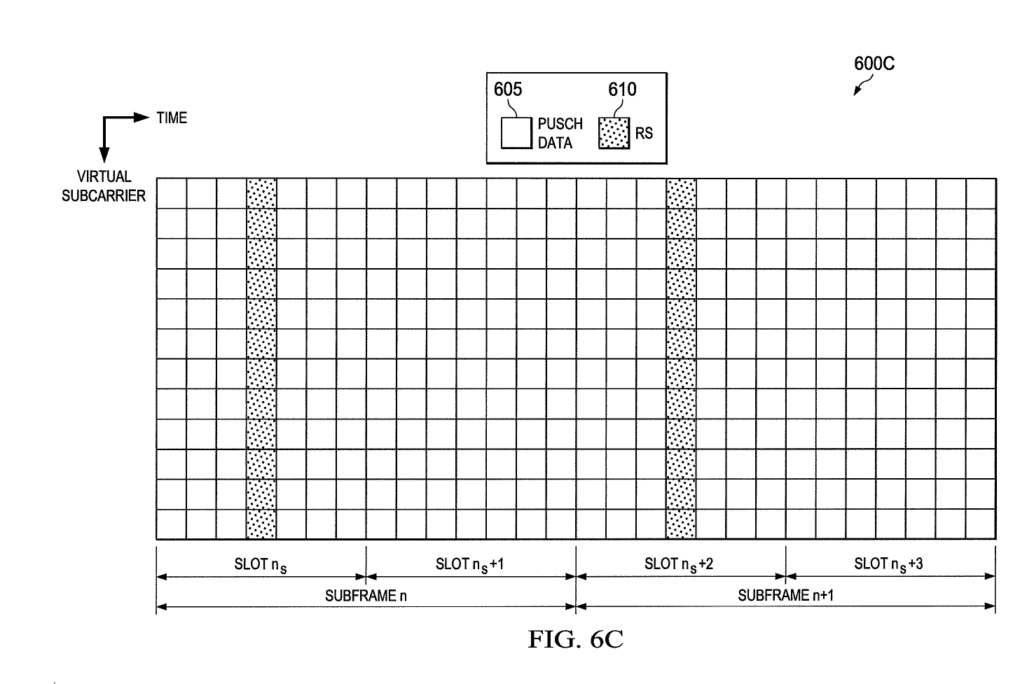

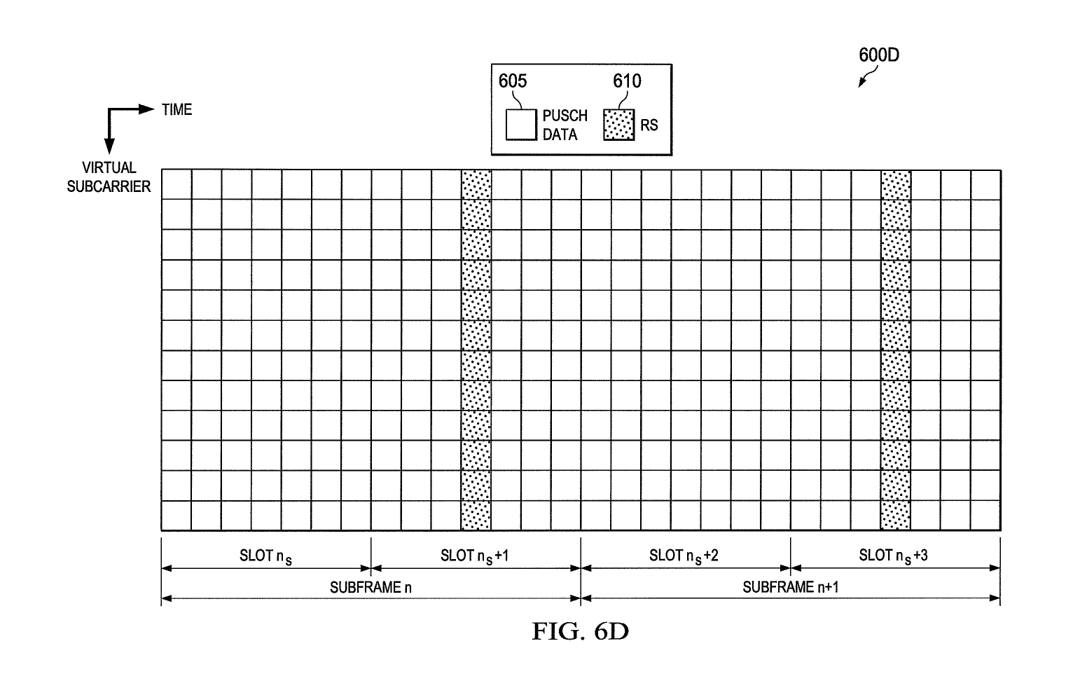

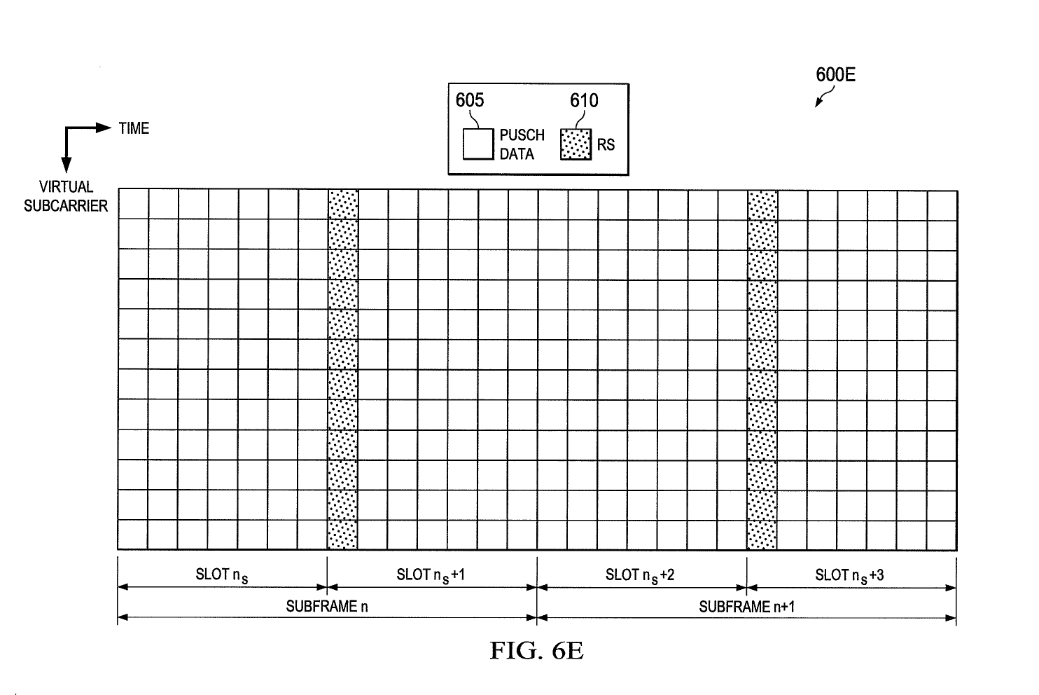

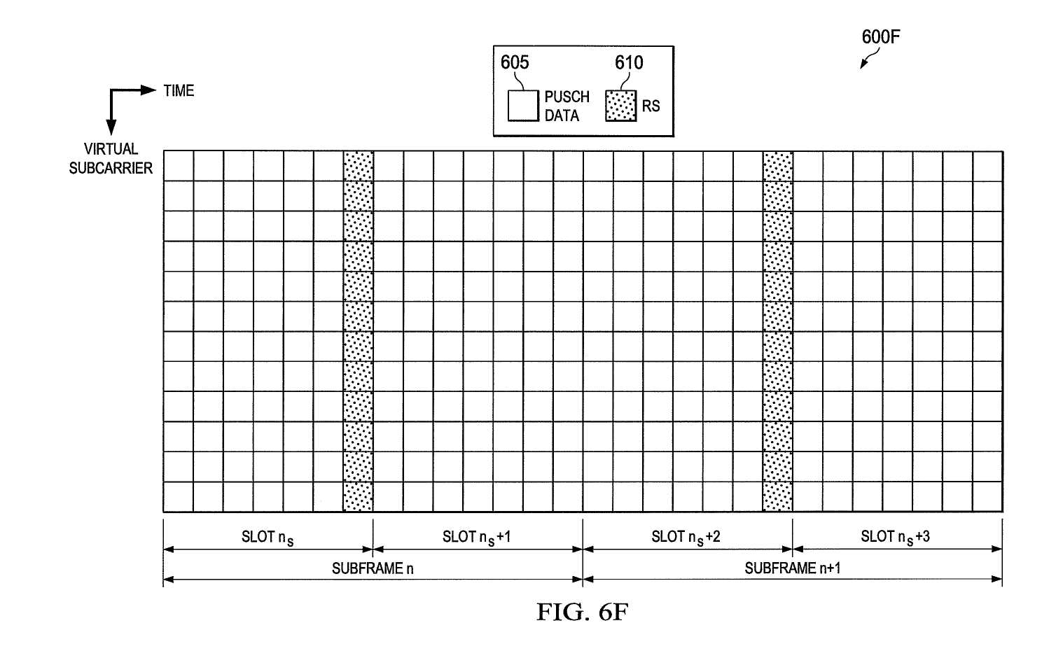

FIGS. 6A-6F illustrate alternative methods to reduce UL DMRS overhead according to an embodiment of the disclosure. Patterns 600 include data 605, data 607, RS 610, subframe n, and subframe n+1.

In an embodiment, pattern 600A illustrates a PUSCH mapping of a PUSCH and DMRS of the PUSCH when a PUSCH is scheduled with TTI bundling. In this embodiment, a single data TB is coded and modulated to be mapped across two TTIs (i.e., two subframes) in a scheduled BW.

In an embodiment, pattern 601A illustrates a mapping of a PUSCH and DMRS of the PUSCH when a PUSCH is scheduled with multi-TTI scheduling. In this embodiment, a single DCI format schedules two data TBs to be transmitted in two separate TTIs (in this embodiment, two consecutive TTIs) in a scheduled BW. Multi-TTI scheduling can be triggered by an UL index field transmitted in a DCI format scheduling PUSCH, e.g., DCI format 0. In one example, an UL index field is a x-bit bitmap, where x can be for example 2 or 3, and each bit of the bitmap indicates a PUSCH scheduling in subframe n+n1, n+n2 or n+n3, when the UL DCI format is received in subframe n. For example, when an UL index is a 2-bit bitmap and a UE receives UL index of ‘11’, then the UE should transmit PUSCH in two subframes of n+n1, n+n2; when the UE receives an UL index of ‘10’, then the UE should transmit PUSCH in only one subframe, subframe n+n1.

In both, pattern 600A and sub pattern frames 601A(TTI bundling or multi-TTI scheduling for PUSCH), a UE is scheduled to transmit a PUSCH in two consecutive subframes in a same PUSCH BW and the UE maps a first PUSCH DMRS in a first time slot of a first (i.e., earlier in time) of the two subframes and a second PUSCH DMRS in a second time slot of the second of the two subframes (the resulting pattern is denoted by FIG. 6A). In this manner, a channel estimation accuracy can be maximized. Otherwise, if the UE is scheduled to transmit PUSCH in one subframe, it uses the DMRS structure in FIG. 4.

In FIG. 6, in order to reduce UL DMRS overhead, the present disclosure considers using only two SC-FDM symbols for UL DMRS mapping in the 2-TTI bundling embodiment (pattern 600A) and in the 2-TTI scheduling embodiment (pattern 601A). In this manner, UL DMRS overhead is reduced to half its conventional value, i.e., to 7.2% for a normal CP subframe and to 8.4% for an extended CP subframe. Furthermore, the present disclosure also considers that two SC-FDM symbols are selected for UL DMRS transmission in the overhead reduction embodiment, out of the four SC-FDM symbols on which conventional UL DMRS are transmitted.

As the UL DMRS overhead reduction is useful for UEs having relatively stationary channels in time and/or frequency domain and relatively large SINR for a channel estimation to be accurate without requiring large UL DMRS resources, a configuration of an UL DMRS overhead reduction can be configured to a UE by a NodeB through higher layer signaling such as Radio Resource Control (RRC) signaling. For example, a new RRC information field, ReducedULDMRSOverhead can be introduced to indicate whether a UE should use reduced overhead DMRS or conventional DMRS when the UE is scheduled a PUSCH transmission with TTI bundling or over multiple TTIs.

In an embodiment, when the low overhead UL DMRS structure is used, it is also likely that the environment has poor scattering. For this reason, the present disclosure considers that a UE can be configured with reduced-overhead UL DMRS only when the UE is configured with UL transmission mode 1 (see also REF3) where only a Single Input Multiple Output (SIMO) Transmission Mode (TM) is allowed. If the UE is configured with reduced-overhead UL DMRS and at the same time if the UE is configured with UL transmission mode 2 where both a SIMO TM and a Single User-Multiple Input Multiple Output (SU-MIMO) TM can be supported, then the UE treats this as an erroneous configuration.

Alternatively, a UE can dynamically switch UL DMRS pattern (conventional or reduced overhead), depending upon a data transmission rank in a PUSCH. When a UE is scheduled to transmit data in a PUSCH with rank 1, the UE uses a reduced UL DMRS pattern; when a UE is scheduled to transmit data in a PUSCH with rank larger than 1, the UE uses a conventional UL DMRS pattern.

Alternatively, a UE can dynamically switch UL DMRS patterns depending upon a DCI format scheduling a respective PUSCH. When a UE is scheduled to transmit PUSCH by DCI format 0 (SIMO DCI format), the UE uses a reduced UL DMRS pattern; when the UE is scheduled to transmit PUSCH by DCI format 4 (MIMO DCI format), the UE uses a conventional UL DMRS pattern.

Alternatively, a UE can dynamically switch UL DMRS patterns depending upon a number of PUSCH TTIs (or subframes) scheduled by a UL related DCI. When a UE is scheduled to transmit PUSCH across multiple (e.g., 2) TTIs (e.g., TTI bundling or by multiple TTI scheduling), the UE uses a reduced UL DMRS pattern; when the UE is scheduled to transmit PUSCH in a single TTI, the UE uses the legacy UL DMRS pattern.

In FIG. 6B, in pattern 600B, both SC-FDM symbols carrying DMRS are in the first subframe of two consecutive subframes. Pattern 600B facilitates a UE to obtain relatively reliable channel estimates fast (small latency for channel estimation) and use the reliable channel estimates for the demodulation of the subsequent subframe.

In FIG. 6C, in pattern 600C, both SC-FDM symbols carrying DMRS are in the first time slot of two consecutive subframes. Pattern 600C facilitates a UE to obtain relatively reliable channel estimates fast (small latency for channel estimation) and use the reliable channel estimates for demodulation of a subsequent subframe. In an embodiment, pattern 600C may be better in terms of reliability of channel estimates while it is worse in terms of latency than pattern 600B.

FIGS. 6E-6F illustrates still other alternative DMRS patterns that can be used for a UE configured with UL DMRS overhead reduction. Pattern 600E, of FIG. 6E, has DMRS on the first SC-FDM symbol in the second slot of each subframe. Pattern 600F, of FIGS. 6F, has DMRS on the last SC-FDM symbol in the first slot of each subframe. Both, pattern 600E and 600F, will provide robust channel estimates that can be used throughout the subframe as the DMRS SC-FDM location is at the center of the subframe in time domain.

In an embodiment, when a same UL DMRS pattern is used by all cells, inter-cell interference on UL DMRS can be high, especially when two neighboring eNBs assign a same UL DMRS sequence to respective UEs in a same BW or when a PUSCH transmission BW and a respective length of an UL DMRS sequence are small. To mitigate inter-cell interference issues, the present disclosure considers that a UE can be configured to use one out of multiple patterns, where the multiple patterns can be a subset of a set of patterns 600A-600D. For example, a UE can be higher-layer configured by RRC or dynamically indicated by a DCI format to use one of the two patterns 600C and 600D. In this embodiment, one-bit signaling is sufficient. In one example, the one bit signaling is included in a DCI format scheduling PUSCH (i.e., DCI format 0/4).

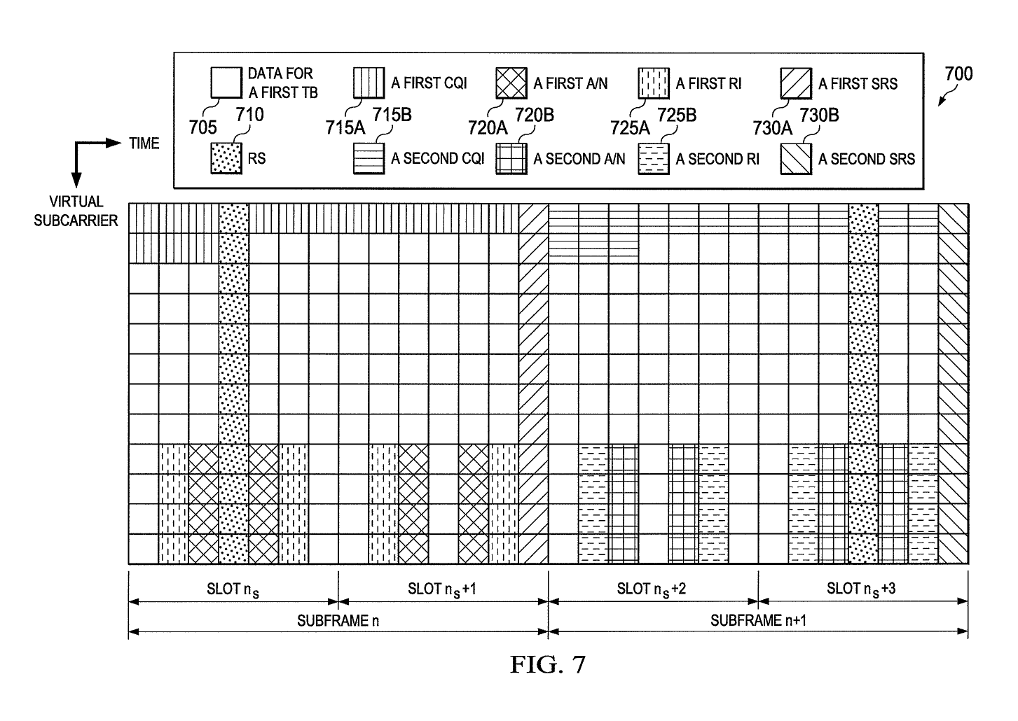

FIG. 7 illustrates an alternative pattern 700 for UCI on PUSCH according to an embodiment of the disclosure. In this embodiment, the UE is scheduled PUSCH over a BW of one PRB pair. In an embodiment, pattern 700 can include data 705, RS 710, CQI 715A, CQI 715B, A/N 720A, A/N 720B, RI 725A, RI 725B, SRS 730A, SRS 730B, subframe n, and subframe n+1.

In this embodiment, a first subframe, subframe n, of two consecutive subframes can carry some or none of CQI 715A, A/N 720A, or RI 725A when a respective PUSCH transmission is scheduled. Additionally, second subframe, subframe n+1, can carry some or none of CQI 715B, A/N 720B, or RI 725B when the respective transmission is scheduled. The multiplexing of a UCI type in a subframe can be according to a respective timing. For example, for a FDD system, A/N in subframe n can correspond to a PDSCH reception by the UE in subframe n−4, if any, while A/N in subframe n+1 can correspond to a PDSCH reception in subframe n−3, if any. For example, for a TDD system, A/N can be conveyed only in subframe n, for PDSCH receptions in a respective window of DL subframes, if any, and there can be no A/N conveyed in subframe n+1. For each subframe of the two subframes, CQI 715, A/N 720 and RI 725 are multiplexed according to a conventional method, i.e., a data and control multiplexing method specified in REF2, on Q′ vREs, wherein Q′ is determined per UCI type per subframe. In the example mapping in pattern 700, all of the first or second CQI 715, A/N 720 and RI 725 are respectively scheduled in the first or the second subframe.

A length of a modulation symbol stream comprising PUSCH data or CQI/PMI is determined based on the reduced DMRS overhead. When a UE is assigned a PUSCH transmission over N_{PRB} PRB pairs then, as each subframe has one more SC-FDM symbol for transmitting data or CQI/PMI, a modulation symbol stream length can be 12·11·N_{PRB} per subframe. As a result, a UE first maps a modulation symbol stream to 12·11·N_{PRB} virtual REs in each subframe. Then, according to a conventional procedure, the data or CQI/PMI modulation symbols on the A/N or RI virtual REs are overwritten with the A/N and RI modulation symbols.

In an embodiment, when pattern 700 is used, a UE may implement its channel estimator for the first subframe to rely only on the first DMRS in the first subframe (i.e., subframe n), as the UE has to wait until it receives the DMRS in the second subframe (subframe n+1) which adds latency in decoding time-sensitive information, e.g., A/N. Considering this UE implementation, a demodulation performance for UCI transmitted in the first subframe can be worse than in the second subframe. In order to cope with this limitation, embodiments of the present disclosure consider that a UE can be configured two separate sets of β_{offset}^{PUSCH} values for the first and the second subframes. In this manner, an eNB can consider a detection reliability difference and compensate for it by appropriately assigning a sufficient Q′ number of vREs for A/N and RI in each of the two subframes. This method can be captured as in the following (assuming PUSCH multi-subframe scheduling or PUSCH subframe bundling over two subframes but it can be generalized in a similar manner for more than two subframes).

In an embodiment, when a UE is not configured with UL DMRS overhead-reduction, offset values are defined for single codeword PUSCH transmission and multiple codeword PUSCH transmission. Single codeword PUSCH transmission offsets β_{offset}^{HARQ-ACK}, β_{offset}^{RI} and β_{offset}^{CQI} shall be configured to values according to Table 8.6.3-1,2,3 in REF3 with the higher layer signaled indexes I_{offset}^{HARQ-ACK}, I_{offset}^{RI}, and I_{offset}^{CQI}, respectively. Multiple codeword PUSCH transmission offsets β_{offset}^{HARQ-ACK}, β_{offset}^{RI} and β_{offset}^{CQI} shall be configured to values according to Table 8.6.3-1,2,3 of REF3 with the higher layer signaled indexes I_{offset,MC}^{HARQ-ACK}, I_{offset,MC}^{RI} and I_{offset,MC}^{CQI}, respectively.

In an embodiment, when a UE is configured with UL DMRS overhead reduction, for each of a first and a second subframe in multi-TTI scheduling (or in TTI bundling), offset values are defined for single codeword PUSCH transmission and multiple codeword PUSCH transmission. The first and the second subframes are respectively indexed by x, x=1 and 2. For each of x=1 and 2, the following parameters are configured. Single codeword PUSCH transmission offsets β_{offset}^{HARQ-ACK}, β_{offset}^{RI} and β_{offset}^{CQI} shall be configured to values according to Table 8.6.3-1,2,3 in REF3 with the higher layer signaled indexes I_{offset,x}^{HARQ-ACK}, I_{offset,x}^{RI}, and I_{offset,x}^{CQI}, respectively. Multiple codeword PUSCH transmission offsets β_{offset}^{HARQ-ACK}, β_{offset}^{RI} and β_{offset}^{CQI} shall be configured to values according to Table 8.6.3-1,2,3 with the higher layer signaled indexes I_{offset,MC,x}^{HARQ-ACK}, I_{offset,MC,x}^{RI} and I_{offset,MC,x}^{CQI}, respectively.

In an embodiment, when a UE is configured with UL DMRS overhead reduction, and when the UE is allowed to transmit a first type and a second type of PUSCH in different subframes, the channel estimation accuracy for UCI decoding varies over those two different types of PUSCH decoding, wherein in the first type of PUSCH legacy PUSCH UL DMRS is transmitted, while in the second type of PUSCH UL DMRS overhead reduction is applied. To cope with this UCI decoding accuracy issues, it is proposed to be able to configure two sets of beta offsets for the UE.

For each of the first and the second types of PUSCH, β_{offset}^{PUSCH} values are defined for single codeword PUSCH transmission and multiple codeword PUSCH transmission. The first and the second types are respectively indexed by x, x=1 and 2. For each of x=1 and 2, the following parameters are configured. Single codeword PUSCH transmission offsets β_{offset}^{HARQ-ACK}, β_{offset}^{RI}, and β_{offset}^{CQI} shall be configured to values according to Table 8.6.3-1,2,3 in REF3 with the higher layer signaled indexes I_{offset,x}^{HARQ-ACK}, I_{offset,x}^{RI}, and I_{offset,x}^{cQI}, respectively. Multiple codeword PUSCH transmission offsets β_{offset}^{HARQ-ACK}, β_{offset}^{RI} and β_{offset}^{cQI} shall be configured to values according to Table 8.6.3-1,2,3 with the higher layer signaled indexes I_{offset,MC,x}^{HARQ-ACK}, I_{offset,MC,x}^{RI} and I_{offset,MC,x}^{cQI}, respectively.

TABLE 8.6.3-1
Mapping of HARQ-ACK offset values and the
index signaled by higher layers

| I_{offset}^{HARQ-ACK} or | |
|---|---|
| I_{offset, MC}^{HARQ-ACK} | β_{offset}^{HARQ-ACK} |
| 0 | 2.000 |
| 1 | 2.500 |
| 2 | 3.125 |
| 3 | 4.000 |
| 4 | 5.000 |
| 5 | 6.250 |
| 6 | 8.000 |
| 7 | 10.000 |
| 8 | 12.625 |
| 9 | 15.875 |
| 10 | 20.000 |
| 11 | 31.000 |
| 12 | 50.000 |
| 13 | 80.000 |
| 14 | 126.000 |
| 15 | 1.0 |

TABLE 8.6.3-2
Mapping of RI offset values and the index
signaled by higher layers

| I_{offset}^{RI} or I_{offset, MC}^{RI} | β_{offset}^{RI} |
|---|---|
| 0 | 1.250 |
| 1 | 1.625 |
| 2 | 2.000 |
| 3 | 2.500 |
| 4 | 3.125 |
| 5 | 4.000 |
| 6 | 5.000 |
| 7 | 6.250 |
| 8 | 8.000 |
| 9 | 10.000 |
| 10 | 12.625 |
| 11 | 15.875 |
| 12 | 20.000 |
| 13 | reserved |
| 14 | reserved |
| 15 | reserved |

TABLE 8.6.3-3
Mapping of CQI offset values and the index
signaled by higher layers

| I_{offset}^{CQI} or I_{offset, MC}^{CQI} | β_{offset}^{CQI} |
|---|---|
| 0 | reserved |
| 1 | reserved |
| 2 | 1.125 |
| 3 | 1.250 |
| 4 | 1.375 |
| 5 | 1.625 |
| 6 | 1.750 |
| 7 | 2.000 |
| 8 | 2.250 |
| 9 | 2.500 |
| 10 | 2.875 |
| 11 | 3.125 |
| 12 | 3.500 |
| 13 | 4.000 |
| 14 | 5.000 |
| 15 | 6.250 |

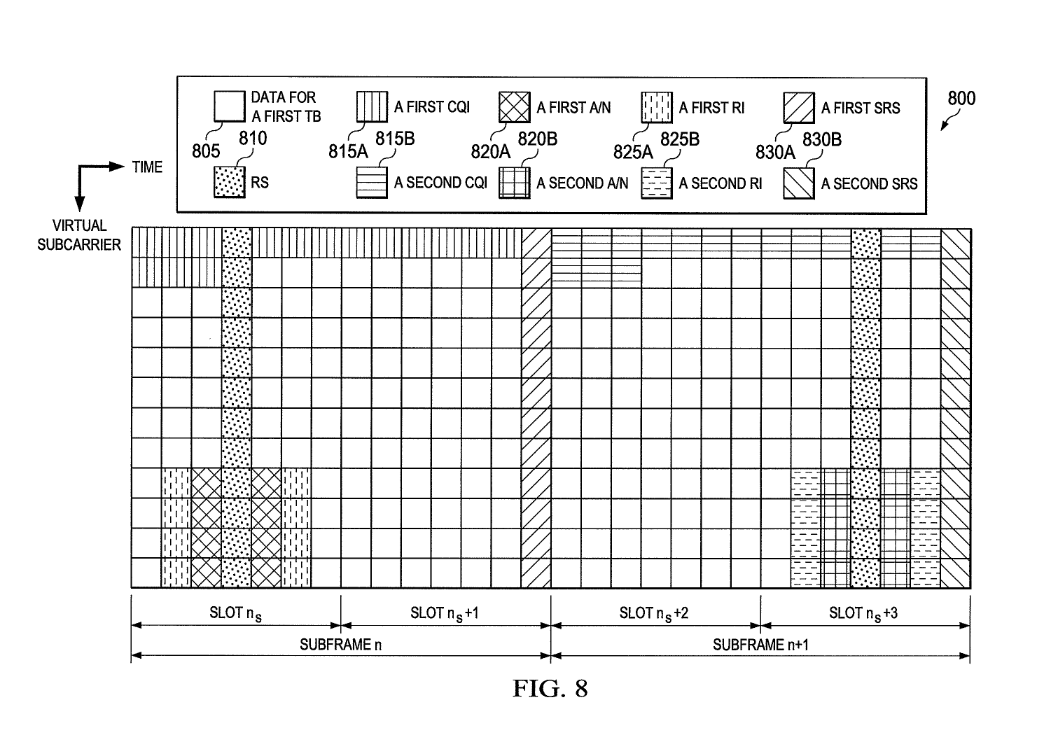

FIG. 8 illustrates an alternative pattern 800 for UCI mapping on PUSCH according to an embodiment of the disclosure. In this embodiment, the PUSCH is scheduled over a BW of one PRB pair. In an embodiment, pattern 800 can include data 805, RS 810, CQI 815A, CQI 815B, A/N 820A, A/N 820B, RI 825A, RI 825B, SRS 830A, SRS 830B, subframe n, and subframe n+1.

In this alternative, HARQ-ACK and RI are mapped around only a single DMRS in each subframe. For example, a first HARQ-ACK is mapped on corresponding Q′ vREs around a DMRS in slot ns in subframe n (which is the first subframe), and a second HARQ-ACK is mapped on corresponding Q′ vREs around the DMRS in slot ns+3 in subframe n+1 (which is the second subframe).

PUSCH data and CQI are coded, modulated and rate matched in a same manner as in the first alternative to generate 12·11·N_{PRB} modulation symbols per subframe. The modulation symbols are mapped onto 12·11·N_{PRB} vREs. As only DMRS in the first time slot in the first subframe and DMRS in the second time slot in the second subframe exist, the first A/N or the first RI are mapped around the DMRS in the first slot in the first subframe, and the second A/N or the second RI are mapped around the DMRS in the second slot in the second subframe.

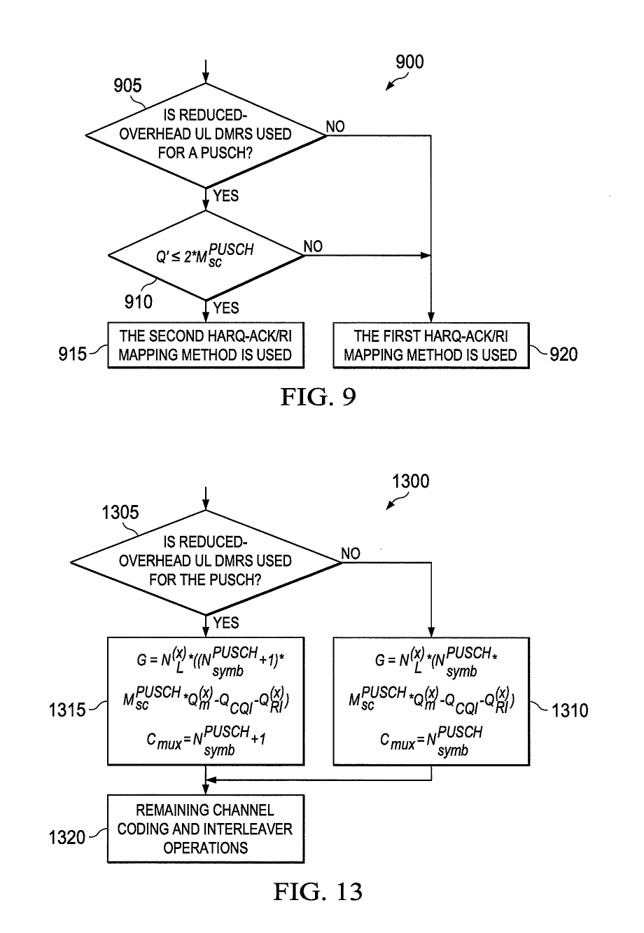

FIG. 9 illustrates a process 900 of an alternative for UCI mapping on PUSCH according to an embodiment of the disclosure. In this embodiment, a UE determines whether to use a first or a second HARQ-ACK/RI mapping method in each subframe when the UE is configured to use a single SC-FDM symbol for DMRS for each scheduled PUSCH.

At operation 905, a UE determines if reduced-overhead UL DMRS is used for a PUSCH. If yes, then at operation 910 the UE determines if Q′≦2·M_{sc}^{PUSCH}. If yes, then at operation 915, the UE uses a second HARQ-ACK/RI mapping method.

In an embodiment, when the UE determines to use the second HARQ-ACK/RI mapping method, the UE maps HARQ-ACK/RI in two SC-FDM symbols in the subframe as in the embodiment associated with FIG. 8. In this embodiment, the total number of REs available for mapping HARQ-ACK/RI is 2·M_{sc}^{PUSCH}.

If at operation 905, the reduced-overhead UL DMRS is not used or if at operation 910, Q′>2·M_{sc}^{PUSCH} then at operation 920, the UE uses a first HARQ-ACK/RI mapping method. In an embodiment, when the UE determines to use the first HARQ-ACK/RI mapping method, the UE maps HARQ-ACK/RI in four SC-FDM symbols in the subframe as in the embodiment associated with FIG. 7. In this embodiment, the total number of REs available for mapping HARQ-ACK/RI is 4·M_{sc}^{PUSCH}.

In one method, as illustrated in FIG. 9, when the number of REs (Q′) to map HARQ-ACK/RI is less than or equal to 2·M_{sc}^{PUSCH}, the UE uses the second HARQ-ACK/RI mapping method; when the number of REs (Q′) to map HARQ-ACK/RI is less than 2·M_{sc}^{PUSCH}, the UE uses the first HARQ-ACK/RI mapping method.

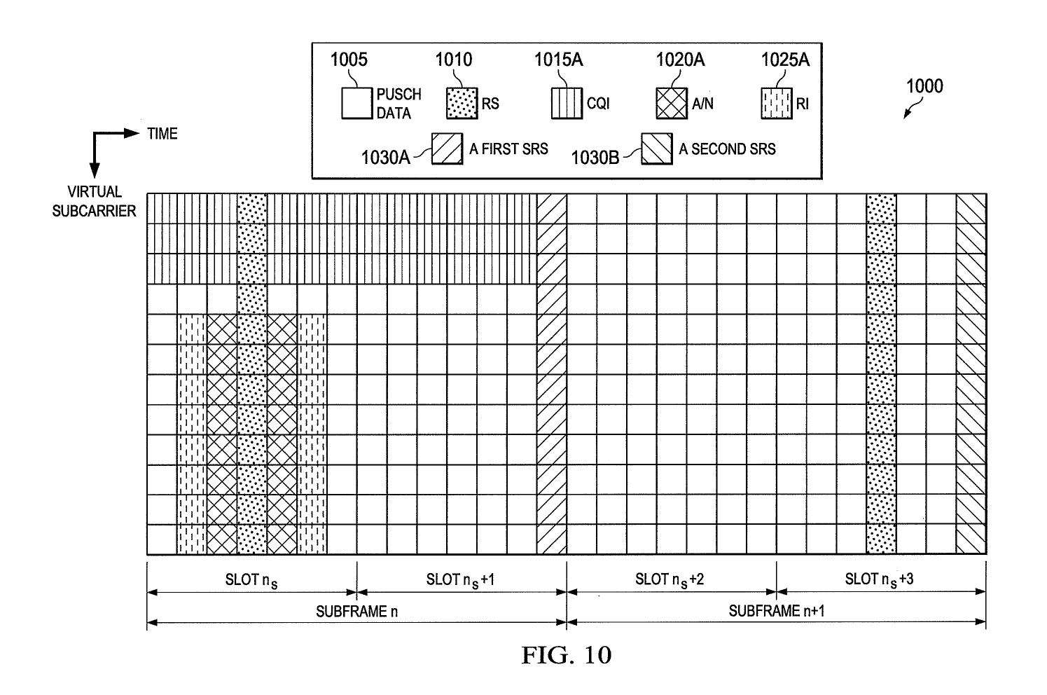

FIG. 10 illustrates an alternative pattern 1000 for UCI mapping over two consecutive subframes scheduled for PUSCH transmission to a UE according to an embodiment of the disclosure. In this embodiment, the PUSCH is scheduled over a BW of one PRB pair. In an embodiment, pattern 1000 can include data 1005, RS 1010, CQI 1015A, A/N 1020A, RI 1025A, SRS 1030A, SRS 1030B, subframe n, and subframe n+1.

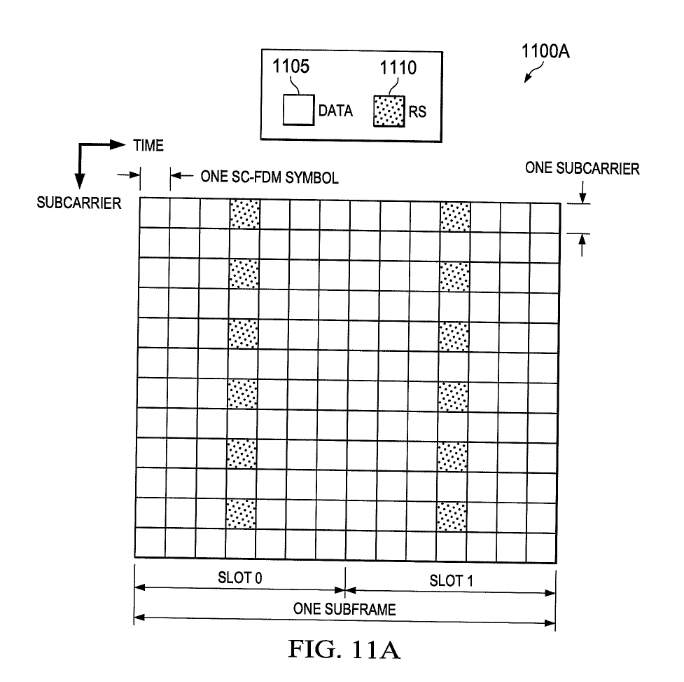

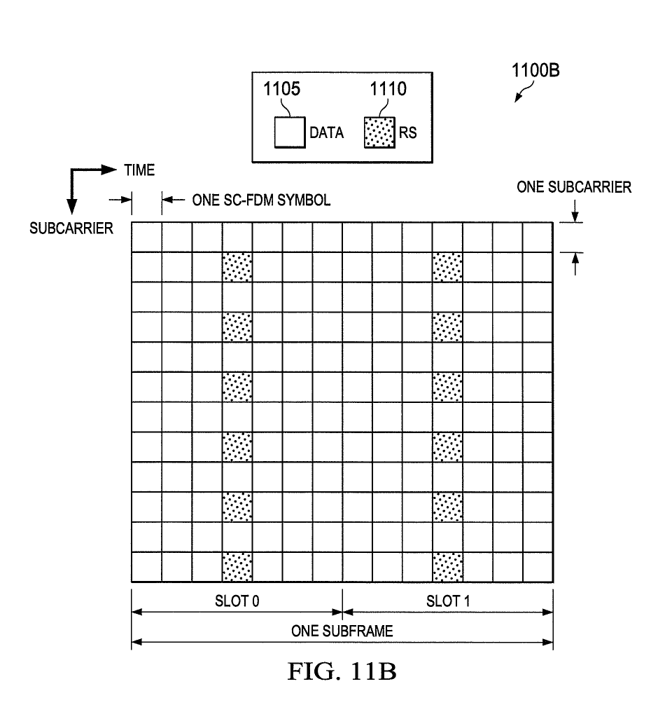

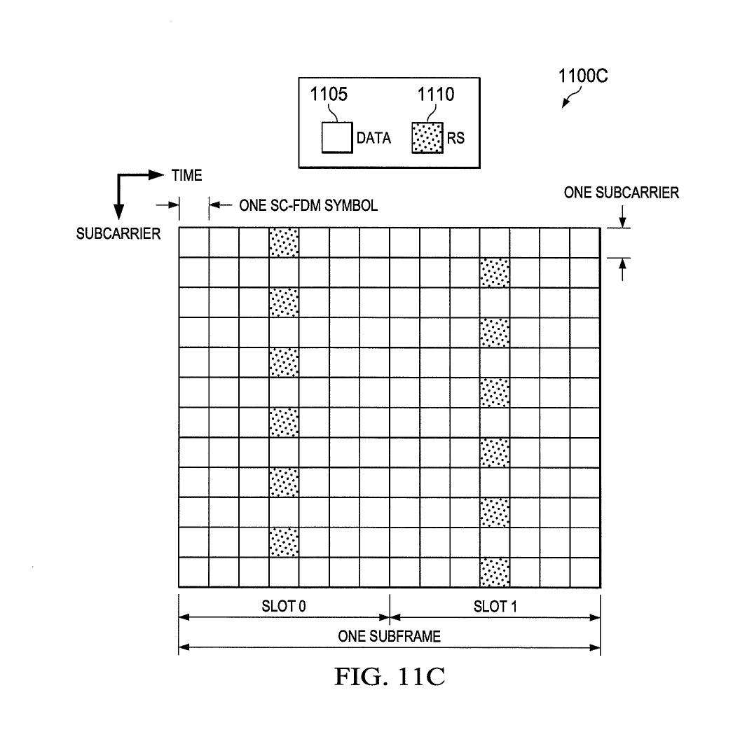

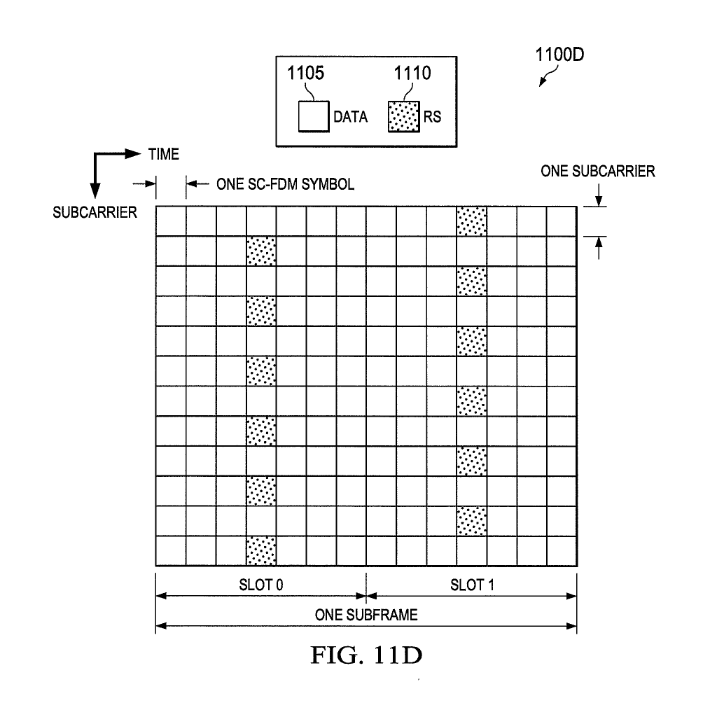

In this embodiment, PUSCH is scheduled over a BW of one PRB pair. The HARQ-ACK 1020A and RI 1025A are mapped on Q′ vREs on the two SC-FDM symbols next to the single DMRS, and CQI on top portion of the PUSCH on the first subframe, and they are not mapped to the second subframe, wherein Q′ is determined per UCI type. This embodiment can to address the latency issue of UCI transmissions—especially for TDD systems and support HARQ-ACK transmissions according to a timing defined relative to the first subframe (or the second subframe). Alternatively, as for FIG. 7, some HARQ-ACK information can be multiplexed only in the first subframe, if a respective HARQ-ACK transmission timing is associated with the first subframe, or can be multiplexed only in the second subframe, if a respective HARQ-ACK transmission timing is associated with the second subframe. FIGS. 11A-11D illustrate methods for reducing PUSCH DMRS overhead according to an embodiment of the disclosure. Patterns 1100 include data 1105, RS 1110, slot 0, and slot 1.

This embodiment uses alternating sub-carriers for DMRS mapping (frequency comb), or frequency-domain sub-sampling with factor two. A starting offset for the sub-samples, referred to as comb shift in FIG. 11, can be either “0” or “1”. FIG. 11 illustrates four example patterns 1100 for configuring comb shifts in the two time slots of a subframe. In pattern 1100A, the comb shift is (0, 0); in pattern 1100B, the comb shift is (1,1); in pattern 1100C, the comb shift is (0,1); in pattern 1100D, the comb shift is (1,0).

The comb shifts for the two slots of a subframe can be configured to each UE either by higher-layer signaling such as RRC signaling or by physical layer signaling (i.e., via a code-point in a DCI format scheduling a PUSCH). The configurability of the comb shifts can decrease a probability of DMRS collisions between cells.

In FIG. 11, data and DMRS are multiplexed in the frequency domain or RE domain (not in vRE domain) in each of the DMRS SC-FDM symbols. A PAPR (peak-to-average-power ratio) increase in the DMRS SC-FDM symbols, as a resultant time-domain waveform, is not a single-carrier.

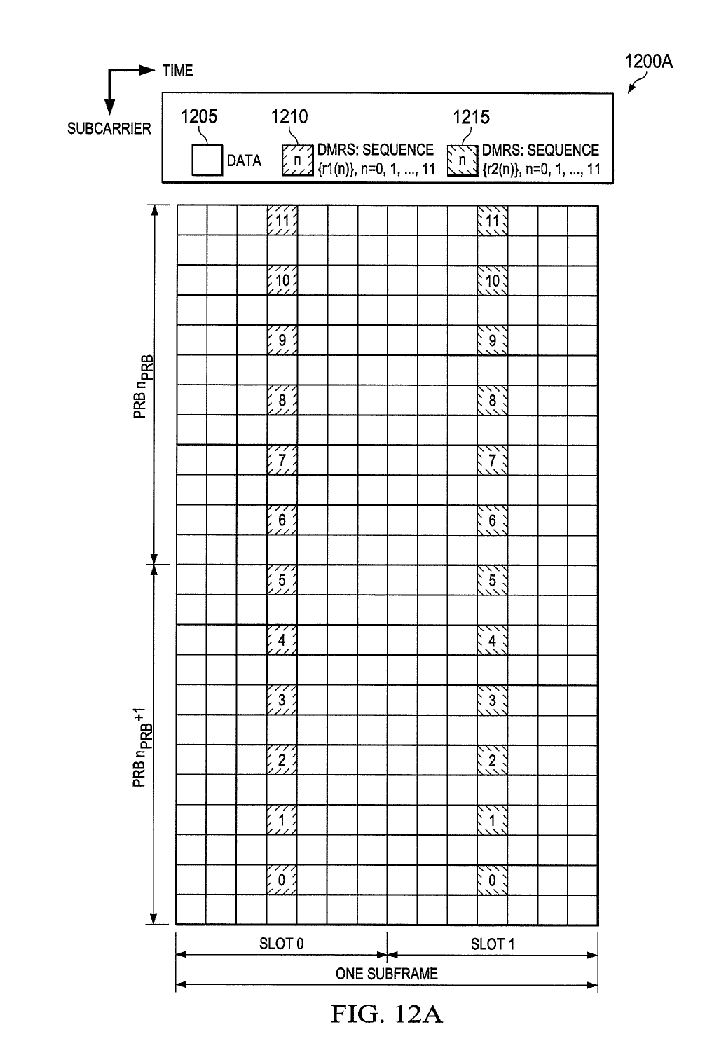

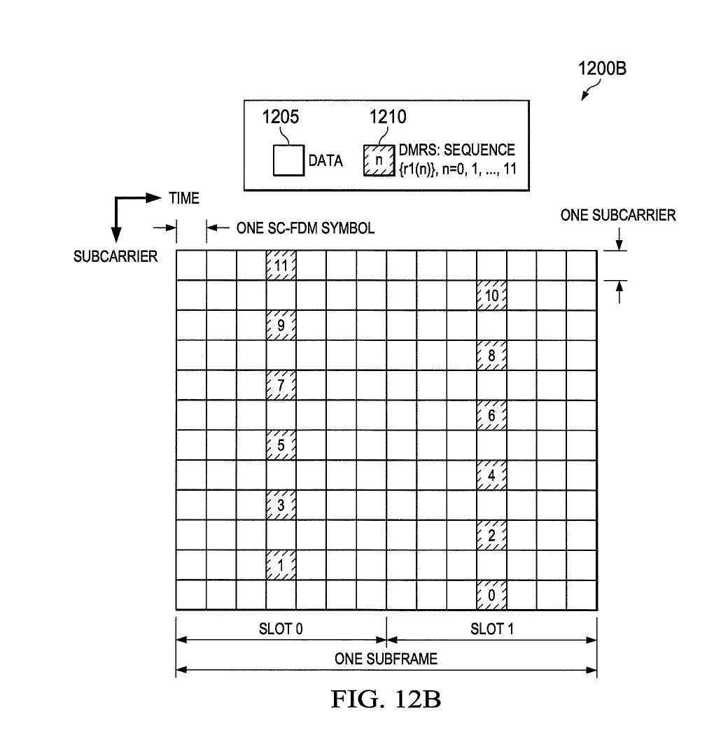

FIGS. 12A and 12B illustrate methods for mapping a DMRS sequence across DMRS REs according to an embodiment of the disclosure. In an embodiment, patterns 1200 include data 1205, a first DMRS sequence 1210, a second DMRS sequence 1215, slot 0, and slot 1.

In pattern 1200A, first DMRS sequence 1210 is mapped onto DMRS REs in the first DMRS SC-FDM symbol, and second DMRS sequence 1215 is mapped onto DMRS REs in the second DMRS SC-FDM symbol. For this method, a long DMRS sequence is used, r_{PUSCH}^{(λ)}(m·M_{sc}^{RS}+n)=w^{(λ)}(m)r_{u,v}^{(α}^{_{λ}}⁾(n), where m=0,1; n=0, . . . , M_{sc}^{RS}−1 and M_{sc}^{RS}=M_{sc}^{PUSCH}/2. In other words, the UE uses half the number of the assigned PUSCH subcarriers.

In an embodiment, w^{(λ)}(m) and r_{u,v}^{(α}^{_{λ}}⁾(n) can be obtained according to the previously described method in the background section. In order to use currently available RS base sequences having a length that is a multiple of twelve (as a minimum BW allocation for a PUSCH transmission is twelve subcarriers), a length of a base sequence r_{u,v}^{(α}^{_{λ}}⁾(n) used for a DMRS with a comb spectrum should also have a length that is a multiple of twelve.

As one way to ensure that a DMRS with a comb in each SC-FDM symbol has a length that is a multiple of twelve, the present disclosure considers that a UE should not expect to receive PUSCH scheduling over an odd number of PRB pairs in a situation where the UE is configured to use reduced-overhead UL DMRS pattern. Therefore, considering a restriction of PUSCH scheduling over an even number of PRB pairs, the present disclosure further considers that a resource allocation (RA) field in an DCI format scheduling a PUSCH transmission (such DCI format 0 or DCI format 4) indicates a PRB allocation in a multiple of two PRB pairs instead of one PRB pair as in a situation where the UE is configured to use conventional DMRS pattern. Therefore, a UE interprets a state of the RA field differently depending upon whether or not the UE is configured to use reduced-overhead DMRS. For example, if a state of a RA field indicates that a UE should transmit PUSCH on PRBs 3, 4, 5, according to a conventional specification, then:

If the UE is configured to use a conventional DMRS pattern, the UE transmits PUSCH on PRBs 3, 4, 5.

If the UE is configured to use a reduced-overhead DMRS pattern, the UE transmit PUSCH on PRBs 6, 7, 8, 9, 10, 11, which is obtained according to: (3×2, 3×2+1), (4×2, 4×2+1), (5×2, 5×2+1).

In another embodiment, to ensure that a DMRS with a comb in each SC-FDM symbol has a length that is a multiple of twelve, embodiments of the present disclosure consider that a UE changes DMRS mapping on a PUSCH depending on whether a number of allocated PRBs for the PUSCH is even or odd. The number of PRBs is indicated in an UL related DCI format (such as DCI format 0 or DCI format 4) that provides scheduling information for a PUSCH transmission. When the number of PRBs is even, the UE multiplexes data and DMRS in the frequency domain as in pattern 1100A. Conversely, when the number of PRBs is odd, the UE maps only DMRS in all the M_{sc}^{PUSCH} assigned subcarriers in the SC-FDM symbols where DMRS is transmitted as in the conventional (or legacy) specification.

In pattern 1100B, the symbols 0, 2, 4, . . . in a base DMRS sequence r_{u,v}^{(α}^{_{λ}}⁾(n), n=0, . . . , M_{sc}^{RS}−1, and M_{sc}^{RS}=M_{sc}^{PUSCH} are mapped onto the DMRS REs in the first DMRS SC-FDM symbol, and the symbols 1, 3, 5, . . . in the same DMRS sequence r_{u,v}^{(α}^{_{λ}}⁾(n) are mapped onto the DMRS in the second DMRS SC-FDM symbol. When pattern 1100B is used, an eNB is allowed to schedule any number of PRBs while using currently available RS base sequences for the embodiment of a conventional DMRS. In an embodiment, pattern 1100B can be useful when the UE speed is low and thus the base sequence mapping across the two SC-FDM symbols does not materially degrade channel estimation accuracy.

Modification of the Channel Coding and Interleaver Block:

In an embodiment, when a reduced overhead PUSCH DMRS is used, more REs are available to carry PUSCH data modulation symbols. For example, when a DMRS and PUSCH mapping as shown above in FIG. 7 is used, M_{sc}^{PUSCH} additional REs can be used for carrying PUSCH data in PRB pairs allocated for PUSCH transmission compared to the embodiment where the two PUSCH DMRS SC-FDM symbols are entirely used to carry only PUSCH DMRS. This implies that depending on whether reduced overhead PUSCH DMRS or conventional PUSCH DMRS is used, a number of coded bits of UL-SCH data, G, and a number of columns in the matrix used for the channel interleaver block change.

FIG. 13 illustrates a process 1300 showing the values for G and Cₘᵤₓ change depending upon whether or not reduced-overhead DMRS is used for a PUSCH transmission according to an embodiment of the disclosure. In operation 1305, a UE determines whether reduced-overhead UL DMRS is used for the PUSCH. At operation 1310, when conventional PUSCH DMRS is used without overhead reduction, G and C^{max} are determined as G=N_{L}^{(x)}·(N_{symb}^{PUSCH}·M_{sc}^{PUSCH}·Qₘ^{(x)}−Q_{CQI}−Q_{RI}^{(x)}) and Cₘᵤₓ=N_{symb}^{PUSCH} where N_{symb}^{PUSCH}=(2·(N_{symb}^{UL}−1)−N_{SRS}). At operation 1315, when reduced-overhead PUSCH DMRS is used, G is determined as G=N_{L}^{(x)}·((N_{symb}^{PUSCH}+1)·M_{sc}^{PUSCH}·Qₘ^{(x)}−Q_{CQI}−Q_{RI}^{(x)}). In addition, Cₘᵤₓ is determined as Cₘᵤₓ=N_{symb}^{PUSCH}+1.

At operation 1320, the UE performed the remaining channel coding and interleaving operations. In an embodiment, the following matrix is constructed in the channel interleaver block, where each vector entry is a column vector of length Qₘ·N_{L}:

$$[ \begin{matrix}{\underline{y}}_{0} & {\underline{y}}_{1} & {\underline{y}}_{2} & … & {\underline{y}}_{{C}_{mux} - 1} \\ {y}_{{C}_{mux}} & {y}_{{C}_{mux} + 1} & {y}_{{C}_{mux} + 2} & … & {y}_{2 {C}_{mux} - 1} \\ ⋮ & ⋮ & ⋮ & ⋱ & ⋮ \\ {\underline{y}}_{\begin{matrix}( {R}_{mux}^{′} - 1 ) \times \\ {C}_{mux}\end{matrix}} & {\underline{y}}_{\begin{matrix}( {R}_{mux}^{′} - 1 ) \times \\ {C}_{mux} + 1\end{matrix}} & {\underline{y}}_{\begin{matrix}( {R}_{mux}^{′} - 1 ) \times \\ {C}_{mux} + 2\end{matrix}} & … & {\underline{y}}_{( {R}_{mux}^{′} \times {C}_{mux} - 1 )}\end{matrix} ] .$$

Transform Precoding and RE Mapping:

In an embodiment, for 3GPP LTE PUSCH, transform precoding is used to reduce a peak-to-average ratio (PAPR) or a cubic metric (CM). It may be desirable to have smaller PAPR or CM as it could imply better power efficiency. When reduced-overhead PUSCH DMRS is introduced, as in FIG. 11, it is desirable to reduce a PAPR increase of SC-FDM symbols with DMRS. The embodiments of this disclosure consider several options to cope with the aforementioned PAPR increase.

In an embodiment, when reduced overhead DMRS is used for a PUSCH transmission, transform precoding (or DFT precoding) is applied for the first (M_{symb}^{layer}/M_{sc}^{PUSCH}−1) sets, as in REF 1 and as previously mentioned for Equation 1, wherein:

$${y}^{( λ )} ( l \cdot {M}_{sc}^{PUSCH} + k ) = \frac{1}{\sqrt{{M}_{sc}^{PUSCH}}} {\sum }_{i = 0}^{{M}_{sc}^{PUSCH} - 1} {x}^{( λ )} ( l \cdot {M}_{sc}^{PUSCH} + i ) {e}^{- j \frac{2 π i k}{{M}_{sc}^{PUSCH}}} \\ k = 0 , … , {M}_{sc}^{PUSCH} - 1 \\ l = 0 , … , {M}_{symb}^{layer} / {M}_{sc}^{PUSCH} - 2 \qquad ( 4 )$$

For the transform precoding of the last set, i.e., (M_{symb}^{layer}/M_{sc}^{PUSCH})-th set (or for l=M_{symb}^{layer}/M_{sc}^{PUSCH}−1), a few alternatives are considered by the present disclosure:

In an embodiment, no transform precoding is applied for the symbols in the last set. In this embodiment,

y^{(λ)}(l·M_{sc}^{PUSCH}+k)=x^{(λ)}(l·M_{sc}^{PUSCH}+i)

k=0, . . . ,M_{sc}^{PUSCH}−1

l=M_{symb}^{layer}/M_{sc}^{PUSCH}−1 (5)

In another embodiment, a single transform precoding is applied for the symbols in the last set of l=M_{symb}^{layer}/M_{sc}^{PUSCH}−1, utilizing the same equation as for the other SC-FDM symbols corresponding to l==0, . . . ,M_{symb}^{layer}/M_{sc}^{PUSCH}−2.

In yet another embodiment, the symbols in the last set are partitioned into two sub-groups of consecutive symbols, and the two subgroups are separately transform precoded. In this embodiment, with M_{sc}′^{PUSCH}=M_{sc}^{PUSCH}/2,

$${y}^{( λ )} ( l \cdot {M}_{sc}^{PUSCH} + k ) = \frac{1}{\sqrt{{M}_{sc}^{′ PUSCH}}} {\sum }_{i = 0}^{{M}_{sc}^{′ PUSCH} - 1} {x}^{( λ )} ( l \cdot {M}_{sc}^{′ PUSCH} + i ) {e}^{- j \frac{2 π i k}{{M}_{sc}^{′ PUSCH}}} \\ k = 0 , … , {M}_{sc}^{′ PUSCH} - 1 \\ l = {M}_{symb}^{layer} / {M}_{sc}^{PUSCH} - 1 ; and \\ {y}^{( λ )} ( l \cdot {M}_{sc}^{PUSCH} + k + {M}_{sc}^{′ PUSCH} ) = \frac{1}{\sqrt{{M}_{sc}^{′ PUSCH}}} {\sum }_{i = 0}^{{M}_{sc}^{′ PUSCH} - 1} {x}^{( λ )} ( l \cdot {M}_{sc}^{′ PUSCH} + i + {M}_{sc}^{′ PUSCH} ) {e}^{- j \frac{2 πi k}{{M}_{sc}^{′ PUSCH}}} \\ k = 0 , … , {M}_{sc}^{′ PUSCH} - 1 \\ l = {M}_{symb}^{layer} / {M}_{sc}^{PUSCH} - 1 \qquad ( 6 )$$

The first (M_{symb}^{layer}/M_{sc}^{PUSCH}−1) sets are mapped onto (m_{symb}^{layer}/M_{sc}^{PUSCH}−1) PUSCH data SC-FDM symbols according to REF 1, and the last set is partitioned into two subgroups of length M_{sc}′^{PUSCH}=M_{sc}^{PUSCH}/2 consecutive symbols of y^{(λ)(l·M}_{sc}^{PUSCH}+k), k=0, . . . , M_{sc}^{PUSCH}−1 and l=M_{symb}^{layer}/M_{sc}^{PUSCH}−1. Then, modulation symbols in the subgroups are mapped onto the data REs of the DMRS SC-FDM symbols according to the previous embodiments, e.g., in FIG. 7 or FIG. 8.

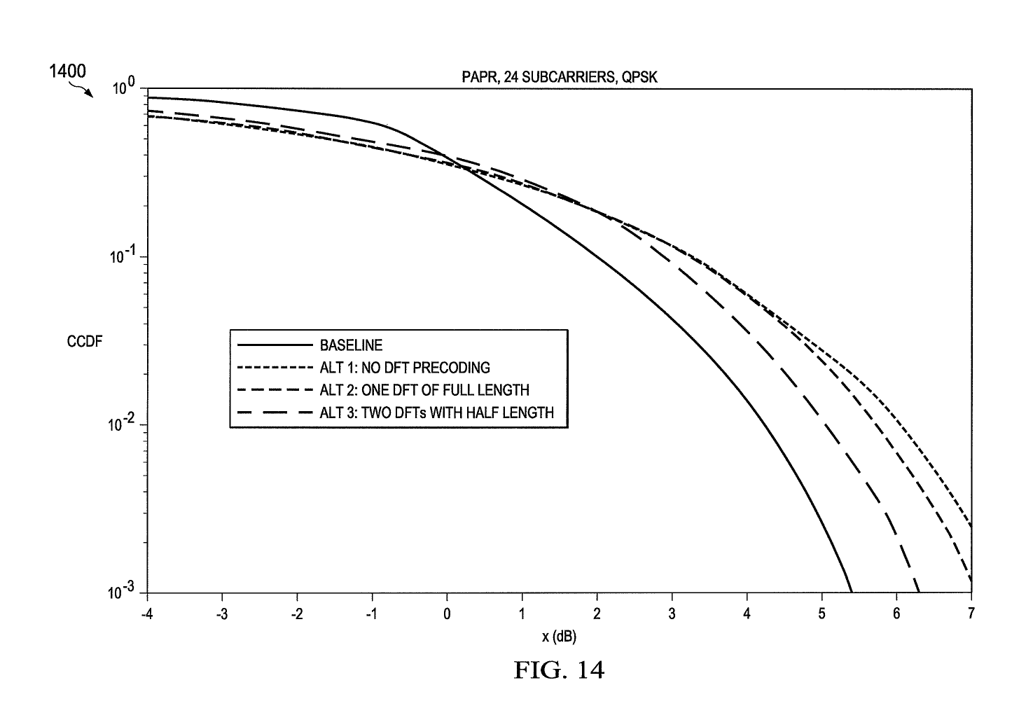

FIG. 14 illustrates PAPR comparison results 1300 for transform precoding according to an embodiment of the disclosure. The “baseline” curve corresponds to the CCDF of the transform-precoded PUSCH data SC-FDM symbol. As shown above, that among those three alternatives, Alt 3 achieves the smallest PAPR which is only one dB worse than the baseline at 10-2 CCDF. It is also noted that Alt 1 and Alt 2 suffer from 2 dB and 1.8 dB PAPR loss at 10-2 CCDF, respectively. However, Alt 1 uses the constraint of M_{RB}′^{PUSCH}=2^{α}^{₂}·3^{α}^{₃}·5^{α}^{₅}≦N_{RB}^{UL} for M_{sc}′^{PUSCH}=M_{sc}^{PUSCH}/2, as well as M_{RB}^{PUSCH}=2^{α}^{₂}·3^{α}^{₃}·5^{α}^{₅}≦N_{RB}^{UL}, which use stricter scheduling restriction. For example, in some embodiments, a UE is not expected to receive PUSCH PRB allocation in a UL grant that violates the two constraints if reduced-overhead DMRS is configured.

If the scheduling restriction is too severe, Alt 2 can be selected even if it results to a somewhat larger PAPR compared to Alt 3. Alt 1 uses least complexity.

What is claimed is:

1. For use in a wireless network, a user equipment (UE) comprising:
a transceiver configured to:
transmit a physical uplink shared channel (PUSCH), wherein the PUSCH comprises:
a demodulation reference signal (DMRS) mapped on a single, single carrier frequency division multiplexing (SC-FDM) symbol of a subframe, and
data and acknowledgement (HARQ-ACK) information mapped on remaining SC-FDM symbols of the subframe, and
wherein the HARQ-ACK information is mapped on virtual subcarriers on two SC-FDM symbols next to the single SC-FDM symbol with the DMRS.

2. The UE of claim 1, wherein the transceiver is further configured to:
determine whether Q′≦2·M_{sc}^{PUSCH},
wherein Q′ is a number of resource elements to map the HARQ-ACK information, and M_{sc}^{PUSCH} is the number of subcarriers carrying the PUSCH in the subframe;
responsive to Q′≦2·M_{sc}^{PUSCH}, map the HARQ-ACK information to only the two SC-FDM symbols next to the single SC-FDM symbol with the DMRS; and
responsive to Q′>2·M_{sc}^{PUSCH}, map the HARQ-ACK information to only four SC-FDM symbols, wherein one of the two pairs of the four SC-FDM symbols is next to the single SC-FDM symbol with the DMRS.

3. The UE of claim 1, wherein the transceiver is further configured to:
transmit the PUSCH in the subframe and another subframe, wherein the subframe and the other subframe are consecutive,
wherein a first set of beta offsets are used for determining a number of resource elements to map a first uplink control information (UCI) on the subframe and a second set of beta offsets are used for determining a number of resource elements to map a second UCI on the other subframe,
wherein the first set of beta offsets for single codeword PUSCH transmission β_{offset}^{HARQ-ACK}, β_{offset}^{RI}, and β_{offset}^{CQI} according to higher layer signaled indexes I_{offset,x}^{HARQ-ACK}, I_{offset,x}^{RI}, and I_{offset,x}^{CQI}, respectively, and
wherein the first UCI comprises at least one of the HARQ-ACK information, rank indicators (RI) and channel quality indicators (CQI).

4. The UE of claim 1, wherein the DMRS is mapped on the single SC-FDM symbol if a rank of the PUSCH is 1, and wherein the DMRS is mapped on two SC-FDM symbols and the data and HARQ-ACK information is mapped on the remaining SC-FDM symbols if the rank of the PUSCH is greater than 1.

5. The UE of claim 1, wherein the DMRS is mapped on the single SC-FDM symbol if the PUSCH is scheduled by DCI format 0, and wherein the DMRS is mapped on two SC-FDM symbols and the data and HARQ-ACK information is mapped on the remaining of the SC-FDM symbols if the PUSCH is scheduled by DCI format 4.

6. For use in a wireless network, a base station (BS) comprising:
a transceiver configured to:
receive a physical uplink shared channel (PUSCH), wherein the PUSCH comprises:
a demodulation reference signal (DMRS) mapped on a single, single carrier frequency division multiplexing (SC-FDM) symbol of a subframe, and
data and acknowledgement (HARQ-ACK) information mapped on remaining SC-FDM symbols of the subframe, and
wherein the HARQ-ACK information is mapped on virtual subcarriers on two SC-FDM symbols next to the single SC-FDM symbol with the DMRS.

7. The BS of claim 6,
wherein the HARQ-ACK is mapped to only the two SC-FDM symbols next to the single SC-FDM symbol with the DMRS in response to Q′≦2·M_{sc}^{PUSCH},
wherein Q′ is a number of resource elements to map the HARQ-ACK information, and M_{sc}^{PUSCH} is the number of subcarriers carrying the PUSCH in the subframe,
wherein the HARQ-ACK information is mapped to only four SC-FDM symbols in response to Q′>2·M_{sc}^{PUSCH}, and
wherein one of the two pairs of the four SC-FDM symbols is next to the single SC-FDM symbol with the DMRS.

8. The BS of claim 6, wherein the transceiver is further configured to:
receive the PUSCH in the subframe and another subframe, wherein the subframe and the other subframe are consecutive,
wherein a first set of beta offsets are used for determining a number of resource elements to map a first uplink control information (UCI) on the subframe and a second set of beta offsets are used for determining a number of resource elements to map a second UCI on the other subframe,
wherein the first set of beta offsets for single codeword PUSCH transmission β_{offset}^{HARQ-ACK}, β_{offset}^{RI}, and β_{offset}^{CQI} according to higher layer signaled indexes I_{offset,x}^{HARQ-ACK}, I_{offset,x}^{RI}, and I_{offset,x}^{CQI}, respectively, and
wherein the first UCI comprises at least one of the HARQ-ACK information, rank indicators (RI) and channel quality indicators (CQI).

9. The BS of claim 6, wherein the DMRS is mapped on the single SC-FDM symbol if a rank of the PUSCH is 1, and wherein the DMRS is mapped on two SC-FDM symbols and the data and HARQ-ACK information is mapped on the remaining SC-FDM symbols if the rank of the PUSCH is greater than 1.

10. The BS of claim 6, wherein the DMRS is mapped on the single SC-FDM symbol if the PUSCH is scheduled by DCI format 0, and wherein the DMRS is mapped on two SC-FDM symbols and the data and HARQ-ACK information is mapped on the remaining of the SC-FDM symbols if the PUSCH is scheduled by DCI format 4.

11. A method for communicating with a base station (BS), the method comprising:
transmitting a physical uplink shared channel (PUSCH), wherein the PUSCH comprises:
a demodulation reference signal (DMRS) mapped on a single, single carrier frequency division multiplexing (SC-FDM) symbol of a subframe, and
data information and acknowledgement (HARQ-ACK) information mapped on remaining SC-FDM symbols of the subframe, and
wherein the HARQ-ACK information is mapped on virtual subcarriers on two SC-FDM symbols next to the single SC-FDM symbol with the DMRS.

12. The method of claim 11, further comprising:
determining whether Q′≦2·M_{sc}^{PUSCH},
wherein Q′ is a number of resource elements to map the HARQ-ACK information, and M_{sc}^{PUSCH} is the number of subcarriers carrying the PUSCH in the subframe;
responsive to Q′≦2·M_{sc}^{PUSCH}, mapping the HARQ-ACK information to only the two SC-FDM symbols next to the single SC-FDM symbol with the DMRS; and
responsive to Q′>2·M_{sc}^{PUSCH}, mapping the HARQ-ACK information to only four SC-FDM symbols, wherein one of the two pairs of the four SC-FDM symbols is next to the single SC-FDM symbol with the DMRS.

13. The method of claim 11, further comprising:
transmitting the PUSCH in the subframe and another subframe, wherein the subframe and the other subframe are consecutive,
wherein a first set of beta offsets are used for determining a number of resource elements to map a first uplink control information (UCI) on the subframe and a second set of beta offsets are used for determining a number of resource elements to map a second UCI on the other subframe,
wherein the first set of beta offsets for single codeword PUSCH transmission β_{offset}^{HARQ-ACK}, β_{offset}^{RI}, and β_{offset}^{CQI} according to higher layer signaled indexes I_{offset,x}^{HARQ-ACK}, I_{offset,x}^{RI}, and I_{offset,x}^{CQI}, respectively, and
wherein the first UCI comprises at least one of the HARQ-ACK information, rank indicators (RI) and channel quality indicators (CQI).

14. The method of claim 11, wherein the DMRS is mapped on the single SC-FDM symbol if a rank of the PUSCH is 1, and wherein the DMRS is mapped on two SC-FDM symbols and the data and HARQ-ACK information is mapped on the remaining SC-FDM symbols if the rank of the PUSCH is greater than 1.

15. The method of claim 11, wherein the DMRS is mapped on the single SC-FDM symbol if the PUSCH is scheduled by DCI format 0, and wherein the DMRS is mapped on two SC-FDM symbols and the data and HARQ-ACK information is mapped on the remaining of the SC-FDM symbols if the PUSCH is scheduled by DCI format 4.

16. A method for communicating with user equipment (UE), the method comprising:
receiving a physical uplink shared channel (PUSCH), wherein the PUSCH comprises:
a demodulation reference signal (DMRS) mapped on a single, single carrier frequency division multiplexing (SC-FDM) symbol of a subframe, and
data information and acknowledgement (HARQ-ACK) information mapped on remaining SC-FDM symbols of the subframe, and
wherein the HARQ-ACK information is mapped on virtual subcarriers on two SC-FDM symbols next to the single SC-FDM symbol with the DMRS.

17. The method of claim 16,
wherein the HARQ-ACK information is mapped to only the two SC-FDM symbols next to the single SC-FDM symbol with the DMRS in response to Q′≦2·M_{sc}^{PUSCH},
wherein Q′ is a number of resource elements to map the HARQ-ACK information, and M_{sc}^{PUSCH} is the number of subcarriers carrying the PUSCH in the subframe,
wherein the HARQ-ACK information is mapped to only four SC-FDM symbols in response to Q′>2·M_{sc}^{PUSCH}, and
wherein one of the two pairs of the four SC-FDM symbols is next to the single SC-FDM symbol with the DMRS.

18. The method of claim 16, further comprising:
receiving the PUSCH in the subframe and another subframe, wherein the subframe and the other subframe are consecutive,
wherein a first set of beta offsets are used for determining a number of resource elements to map a first uplink control information (UCI) on the subframe and a second set of beta offsets are used for determining a number of resource elements to map a second UCI on the other subframe,
wherein the first set of beta offsets for single codeword PUSCH transmission β_{offset}^{HARQ-ACK}, β_{offset}^{RI}, and β_{offset}^{CQI} according to higher layer signaled indexes I_{offset,x}^{HARQ-ACK}, I_{offset,x}^{RI}, and I_{offset,x}^{CQI}, respectively, and
wherein the first UCI comprises at least one of the HARQ-ACK information, rank indicators (RI) and channel quality indicators (CQI).

19. The method of claim 16, wherein the DMRS is mapped on the single SC-FDM symbol if a rank of the PUSCH is 1, and wherein the DMRS is mapped on two SC-FDM symbols and the data and HARQ-ACK information is mapped on the remaining SC-FDM symbols if the rank of the PUSCH is greater than 1.

20. The method of claim 16, wherein the DMRS is mapped on the single SC-FDM symbol if the PUSCH is scheduled by DCI format 0, and wherein the DMRS is mapped on two SC-FDM symbols and the data and HARQ-ACK information is mapped on the remaining of the SC-FDM symbols if the PUSCH is scheduled by DCI format 4.
